(19) United States
(12) Patent Application Publication
(10) Pub. No.: US 2026/0007117 A1
(43) Pub. Date: Jan. 8, 2026

(54) Weight Based Systems and Methods for Automatically Identifying Animal Waste

(71) Applicant: Automated Pet Care Products, LLC D/B/A Whisker, Auburn Hills, MI (US)

(72) Inventor: Brad Baxter, Bloomfield Hills, MI (US)

(21) Appl. No.: 19/258,162

(22) Filed: Jul. 2, 2025

Related U.S. Application Data
(60) Provisional application No. 63/667,266, filed on Jul. 3, 2024.

(51) Int. Cl. A01K 1/01; A01K 29/00; G01G 19/52

(52) U.S. Cl. CPC A01K 1/0114; A01K 29/005; G01G 19/52

(57) ABSTRACT

A method for identifying a type of waste eliminated by an animal in a litter device, the method including: a) automatically detecting entry of the animal into the litter device by one or more sensing devices, b) automatically detecting departure of the animal from the litter device by the one or more sensing devices; c) automatically accessing and executing one or more waste type identification algorithms by one or more processors to determine the type of waste eliminated by the animal; wherein the type of waste is identified based on one or more measured weight characteristics from the one or more mass sensors; and wherein the waste is identified either the cleaning cycle is executed, after the cleaning cycle is executed, or both.

### CROSS REFERENCE TO RELATED APPLICATIONS

This application claims priority from U.S. Provisional Application No. 63/667,266, filed on Jul. 3, 2024, and which is incorporated herein by reference in its entirety for all purposes.

### FIELD

The present application relates to weight-based systems and methods for automatically distinguishing and identifying urine from feces after elimination from a pet in a litter device. The systems and methods may be particularly useful with automated litter devices employing one or more weight sensors.

### BACKGROUND

As health and wellness become more important as it relates to pets, and more specifically cats, certain data provide valuable insights related to health such as frequency of litter box usage, duration of litter box visits, amount of waste deposited, and weight of the pet. As such, it would be valuable to know the type of waste (i.e., feces or urine) deposited during each visit to the litter box, and the corresponding weight of each waste deposit.

One method that has been explored to date is the use of employing a camera and machine learning to detect the difference between a urine clump and a fecal deposit. However, this can be problematic as cats typically immediately cover their waste (i.e., bury) prior to leaving a litter box. Thus, covering of waste can make it difficult for the camera to have a clear line of sight on the waste. Additionally, if the goal is to capture the waste as it is being eliminated, a cat's body will typically block a clear view of the waste before or as it reaches the litter bed. One such solution which has been proposed is that of Purobot Ultra by PetKit which integrates a camera at a front entry of an automated litter box and captures the image of the waste and litter during a sifting cycle before being deposited into a waste receptacle. A disadvantage with this method is that with clumping litter, there may be minimal visual difference between urine and feces. Camera detection may also be problematic with relation to placement of the camera in close proximity to the litter bed and the ongoing need to maintain the camera free of dust and debris from the litter, waste, fur, and the like.

Another method that has been explored is providing for collection of feces and urine in different portions of a litter box and then weighing either or both portions individually. For example, allowing for feces to remain in an upper container while allowing for urine to pass into a lower container, and isolating the containers with dedicated load cells. One such example is disclosed in U.S. Pat. No. 11,284,599, which is incorporated herein by reference in its entirety. This system and method may allow for urine to be weighed separately from feces. This can be troublesome by creating the need to now clean two separate portions of a litter box, the inability to clean the feces and urine with a single automated mechanism, and creating the need for additional load cells.

A further system and method that has been established is that of a scale in combination with a traditional litter box. One such teaching is found in U.S. Pat. No. 8,797,166, which is incorporated by reference herein. This system and method may be disadvantageous as it relies on measuring the litter box as a whole, requires manual cleaning by a pet owner, does not cooperate with automation, cannot automatically determine when a litter box is cleaned, and may not be able to decipher between multiple uses between cleanings.

As such, what is needed is a system and method which may be integrated into an automated litter box to determine the type of waste (e.g., urine versus feces) eliminated by an animal. What is needed is a system and method compatible with an automated litter box having a rotating chamber, sifting mechanism, and/or waste drawer. What is needed is a system and method which is simple to integrate into an automated litter device without the complexities associated with visual recognition or more complicated sensing schemes. What is needed is a system and method which is able to determine a type of waste and can be integrated into a litter device at a low cost.

### SUMMARY

The present teachings relate to a method for identifying a type of waste eliminated by an animal in a litter device, the method comprising: a) one or more sensing devices detecting entry of the animal into the litter device; b) one or more sensing devices detecting departure of the animal from the litter device; c) one or more processors accessing and executing one or more waste type identification algorithms to determine the type of waste eliminated by the animal.

The present teachings relate to a method for identifying a type of waste eliminated by an animal in a litter device, the method comprising: a) automatically detecting entry of the animal into the litter device by one or more sensing devices, wherein the litter device includes a chamber configured to retain litter and for entry and exit of an animal to eliminate waste therein, and the litter device includes a waste receptacle configured to receive the waste from the chamber, wherein the litter device is configured to automatically execute a cleaning cycle to separate the waste from unused litter and transfer the waste to the waste receptacle, and wherein the one or more sensing devices include one or more mass sensors, one or more emitting sensors, one or more cameras, one or more identification sensors, or a combination thereof; b) automatically detecting departure of the animal from the litter device by the one or more sensing devices; c) automatically accessing and executing one or more waste type identification algorithms by one or more processors to determine the type of waste eliminated by the animal; wherein the type of waste is identified based on one or more measured weight characteristics from the one or more mass sensors; and wherein the waste is identified either while the cleaning cycle is executed, after the cleaning cycle is executed, or both.

The present teachings may relate to one or more waste type identification algorithms including one or more of a gas algorithm, a pre-sift chamber weight algorithm, a pre-sift dwell time algorithm, a post-sift waste bin weight algorithm, a post-sift waste bin weight change algorithm, a post-sift chamber weight algorithm, a camera detection algorithm, the like, or any combination thereof.

The present teachings may be useful in identifying if waste is eliminated when an animal enters a litter device and specifically identifying the type of waste eliminated by the animal. The present teachings may be beneficial in employing one or more sensing devices while keeping complexity, costs, and maintenance to a minimum. The present teachings may provide for an automated means of identifying the waste eliminated by an animal and even executing certain operations, such as a cleaning cycle, to eliminate potential odors associated with the waste before the odors are noticeable by an animal or human.

### BRIEF DESCRIPTION OF DRAWINGS

FIG. 1 is a perspective view of a litter device.

FIG. 2 is a front view of a litter device.

FIG. 3 is a cross-section view of a litter device.

FIG. 4 is a perspective view of a litter device.

FIG. 5 is a perspective view of a scale plate assembly.

FIG. 6 illustrates a schematic of a system including a litter device.

FIG. 7A illustrates a method for determining pre-sift waste weight comparison values.

FIG. 7B illustrates a method for identifying waste type by waste weight before a cleaning cycle.

FIG. 8A illustrates a method for determining post-sift waste bin weight comparison values.

FIG. 8B illustrates a method for identifying waste type by waste bin weight after a cleaning cycle.

FIG. 9 illustrates a method for identifying waste type by chamber weight after a cleaning cycle.

FIGS. 10A-10G illustrate a method for identifying waste type.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Automated Litter Device

The present teachings may relate to a litter device. The teachings may be particularly relevant to a litter device which is an automated litter device. An automated litter device may be any type of litter device which automates cleaning of the device after elimination of waste by an animal. The litter device may be useful by one or more domesticated animals. One or more domesticated animals may include one or more cats, rabbits, ferrets, pigs, dogs, ducks, goats, foxes, the like, or any combination thereof. A litter device may include one in which a chamber rotates to cause rotation of a sifting portion such that the sifting portion passes through litter and segregates waste from the litter. A litter device may include one in which a sifting portion rotates within a chamber to pass through the litter and segregate waste from the litter. A litter device may include an automated sifting scoop which moves axially and passes through litter retained within a stationary litter box to sift and segregate waste from litter.

The litter device may include a bezel, a chamber, a box, a septum, a sifting scoop, a bonnet, a base, a waste receptacle, a track, a hub, an entry barrier, the like, or any combination thereof. The chamber may include an entry opening. The chamber may be configured to hold litter. The chamber may be configured to allow an animal to enter and/or exit. The chamber may be configured to allow an animal to excrete waste within the interior. The chamber may include a septum. The septum may include a sifting portion. The sifting portion may be configured for sifting through litter and separating waste from litter. The litter device may include a waste receptacle. A waste receptacle may be in communication with the chamber. A waste receptacle may be configured to receive waste. A waste receptacle may receive waste from the chamber. The waste receptacle may be referred to as a waste bin. A waste receptacle may be configured as a waste drawer.

The present teachings may be useful for use with an automated litter device having a chamber supported by a base, having a waste drawer, or both. The chamber may be a portion of the device configured to hold litter, where an animal may enter and excrete waste, or both. The chamber may be supported by and/or rest above a base. The chamber may be rotatably supported by the base. The chamber may rotate through one or more cleaning cycles to allow for funneling and disposal of waste. The chamber may have an axis of rotation. The axis of rotation may extend through the entry opening of the chamber. The axis of rotation may be concentric or off-center with the entry opening. The axis of rotation may be a tilted axis of rotation. The tilted axis of rotation may promote funneling and disposal of waste, increased line of sight of one or more sensors, or both. The chamber may include a septum such that rotation of the chamber may result in rotation of a septum which sifts through the litter. The septum may filter clean litter from clumps of waste and guide funneling and/or disposal of the waste. Waste from the chamber may be disposed into a waste drawer. A waste drawer may be located in a support base of the device, below a chamber, adjacent to a chamber, or any combination thereof. A litter dispenser may be affixed to the litter device to replenish litter disposed during cleaning cycles. A bonnet may be located at least partially over a chamber to cover one or more components of the litter device, prevent access to one or more pinch points, or both. A chamber, bezel, cleaning cycle of the chamber, rotational capability, axis of rotation (e.g., tilted rotational axis) base (e.g., support base), bonnet, waste drawer, litter dispenser, and other components of the litter device may be configured such as those disclosed in U.S. Pat. Nos. 8,757,094; 9,433,185; 11,399,502; 11,523,586; and PCT Publication No. WO 2022/087530, which are incorporated herein by reference in their entirety for all purposes.

The litter device may include one or more controllers. The one or more controllers may function to receive one or more signals, transmit one or more signals, execute one or more methods and/or algorithms, control operations of one or more components of the device, or a combination thereof. The one or more controllers may be in communication with and/or include one or more sensing devices, communication modules, networks, other controllers, other electrical components, or any combination thereof. The one or more controllers may be adapted to control operation of one or more electrical components of a litter device. For example, signaling one or more drive sources (e.g., motors) to power on and cause rotation of chamber of a litter device to generate a cleaning cycle. The one or more controllers may automatically receive, interpret, and/or transmit one or more signals. The one or more controllers may be adapted to receive one or more signals from the one or more sensing devices. The one or more controllers may be in electrical communication with one or more sensing devices. The one or more controllers may interpret one or more signals from one or more sensing devices as one or more status signals. The controller may relay the one or more status signals to one or more other controllers, processors, storage mediums computing devices, and/or the like. The one or more controllers may be adapted to receive one or more signals from one or more computing devices. The one or more signals may include one or more instruction signals related to one or more instructions. The one or more instructions may be input by a user into a user interface, stored instructions on a computer readable medium (e.g., software) in one or more computing devices, and/or the like. The one or more controllers may automatically control one or more operations of one or more components upon receipt of one or more signals or instructions. The one or more controllers may reside within or be in communication with the litter device. For example, the one or more controllers may be located within or affixed to a bezel, bonnet, base (e.g., support base), chamber, near an entry opening, the like, or any combination thereof. The one or more controllers may include one or more controllers, microcontrollers, microprocessors, processors, storage mediums, or a combination thereof. One or more suitable controllers may include one or more controllers, microprocessors, or both as described in U.S. Pat. Nos. 8,757,094; 9,433,185; 11,399,502, all of which are incorporated herein by reference in their entirety for all purposes. The one or more controllers may be in communication with and/or include one or more communication modules, processors, storage mediums, circuit boards (e.g., printed circuit board “PCB”), input and/or output peripherals, analog to digital convertors, the like, or any combination thereof.

The litter device may include one or more communication modules. The one or more communication modules may allow for the litter device to receive and/or transmit one or more signals from one or more controllers and/or computing devices, be integrated into a network, or both. The one or more communication modules may have any configuration which may allow for one or more data signals from one or more controllers to be relayed to one or more other controllers, communication modules, communication hubs, networks, computing devices, processors, the like, or any combination thereof located external of the litter device. The one or more communication modules may include one or more wired communication modules, wireless communication modules, or both. A wired communication module may be any module capable of transmitting and/or receiving one or more data signals via a wired connection. One or more wired communication modules may communicate via one or more networks via a direct, wired connection. A wired connection may include a local area network wired connection by an ethernet port. A wired communication module may include a PC Card, PCMCIA card, PCI card, the like, or any combination thereof. A wireless communication module may include any module capable of transmitting and/or receiving one or more data signals via a wireless connection. One or more wireless communication modules may communicate via one or more networks via a wireless connection. One or more wireless communication modules may include a Wi-Fi transmitter, a Bluetooth® transmitter, an infrared transmitter, a radio frequency transmitter, an IEEE 802.15.4 compliant transmitter, cellular radio signal transmitter, Narrowband-Internet of Things (NB-IoT) transmitter, the like, or any combination thereof. A Wi-Fi transmitter may be any transmitter complaint with IEEE 802.11. A communication module may be single band, multi-band (e.g., dual band), or both. A communication module may operate at 2.4 Ghz, 5 Ghz, the like, or a combination thereof. A cellular radio signal transmitter may be any transceiver compatible with any cellular frequency band (e.g., 500, 900, 1,800, 1,900 MHz) and/or network (e.g., 3G, LTE, LTE Cat1, LTE M, 4G, 5G). A communication module may communicate with one or more other communication modules, computing devices, processors, or any combination thereof directly; via one or more communication hubs, networks, or both; via one or more interaction interfaces; or any combination thereof.

The litter device may have or be in communication with one or more sensing devices. The one or more sensing devices may function to sense the presence of waste, sense the presence of a certain type of waste, initiate waste detection, sense the presence of an animal, sense the absence of an animal, the like, or any combination thereof. The one or more sensing devices may receive one or more signals, transmit one or more signals, or a combination thereof. The one or more signals may be related to one or more conditions detected by the sensing device. The one or more conditions may be related to one or more operations of one or more components. The one or more sensing devices may cooperate with one or more other sensing devices which detect one or more conditions of one or more litter device, data related to an animal, or both. The one or more sensing devices may be located in any suitable location of a litter device, affixed to a litter device, in communication with a litter device, distanced from a litter device, the like, or any combination thereof. Based on the one or more conditions sensed, one or more sensing devices may transmit one or more signals to one or more controllers, processors, communication modules, computing devices, the like, or any combination thereof. One or more signals from one or more sensing devices may be converted into one or more signals (e.g., analog to digital, signal to a status signal), data entries, or both by one or more controllers, processors, communication modules, computing devices, or any combination thereof. One or more sensing devices may be configured to detect one or more conditions related to: mass of an animal, presence of an animal, identification of an animal, presence of waste, mass of waste, a type of waste, trait(s) associated with waste, the like, or any combination thereof.

One or more sensing devices may include one or more mass sensors, emitting sensors, identification sensors, cameras, the like, or a combination thereof.

The one or more sensing devices may include one or more mass sensors. The one or more mass sensors may function to monitor a mass of a litter device or portion thereof, monitor a mass of litter, monitor a mass of a chamber, monitor a mass of a waste bin, monitor and/or identify mass of waste, monitor a mass of an animal, identify a presence of an animal within or near a device, identify movement of an animal within a device, identify a presence of waste within one or more portions of a litter device, the like, or any combination thereof. One or more mass sensors may continuously, intermittently, or both monitor for mass and/or changes thereof. The one or more mass sensors may be located at any location in or near a litter device so that any change in mass of the device as a whole, the chamber, the waste bin, presence and/or movement of an animal within or near the device, presence of eliminated waste, or any combination thereof may be detected. The mass sensor may include one or more load cells, resistors, force sensors, switches, controllers, microprocessors, the like, or a combination thereof. Exemplary mass sensors and configurations may be as described in U.S. Pat. Nos. 8,757,094; 9,422,185; 11,399,502; and 11,523,586, all of which are incorporated herein by reference in their entirety.

One or more mass sensors may be included as part of one or more feet, a scale plate forming the base of the litter device, between a chamber and a support base, as part of a support on which the chamber rests, below and/or integrated into a waste drawer, within a base, a scale/mat below the litter device, the like, or any combination thereof. One or more mass sensors may include a single or a plurality of mass sensors. One or more mass sensors may be biased toward a bottom center of a portion of a litter device. One or more mass sensors may be biased toward one or more outer corners of a litter device. One or more mass sensors may be located between a base and a waste receptacle of a litter device. One or more mass sensors may be located between a base and/or mid-support and a chamber of a litter device.

One or more mass sensors which are configured to weigh the entire weight of the litter device may be referred to as one or more device mass sensors. One or more device mass sensors may be located below a base, between a base and a scale plate, at the feet, offset from the feet, the like, or a combination thereof.

One or more mass sensors configured to weigh the chamber, and anything therein, such as litter, waste, and/or an animal, may be referred to as one or more chamber mass sensors. The one or more chamber mass sensors may weigh the chamber in isolation from anything outside of the chamber. The one or more mass sensors may be located below a chamber, between a chamber and a base, between a chamber and a mid-support, and/or otherwise such as to have the mass of the chamber applied thereon. The one or more chamber mass sensors may be configured as in U.S. Provisional Application No. 63/795,837 as filed on Apr. 28, 2025, which is incorporated herein by reference in its entirety for all purposes.

One or more mass sensors configured to weigh the waste bin may be referred to as one or more waste bin mass sensors. The one or more waste bin sensors may function to sustain the weight of the waste bin. The one or more waste bin mass sensors may weigh the waste bin in isolation from anything outside of the waste bin. The one or more waste bin sensors may be located below a waste bin, below a rim of a waste bin, between a waste bin and a base, between a waste bin and a scale plate, the like, or any combination thereof.

The one or more mass sensors may be in communication with one or more controllers, computing devices, processors, communication modules, the like, or any combination thereof. The one or more mass sensors may be directly and/or indirectly connected to one or more controllers, computing devices, processors, communication modules, the like, or any combination thereof. The one or more mass sensors may relay one or more signals relating to a monitored mass to one or more controllers, computing devices, processors, communication modules, or any combination thereof. The one or more mass sensors may relay a presence of mass above and/or below a predetermined mass (e.g., threshold value), a real-time mass, a change in mass, the like, or a combination thereof to one or more controllers, computing devices, processors, communication modules, or any combination thereof. A signal from one or more mass sensors relayed to one or more controllers, computing devices, processors, communication modules, or any combination thereof related to the detected mass may be referred to as a mass signal. One or more mass signals may include device mass signal, chamber mass signal, and/or even waste bin mass signal. The mass signal may be included as a status signal.

The one or more sensing devices may include one or more emitting sensors. The one or more emitting sensors may detect a presence of an animal at, in, and/or near a litter device; entry and/or exit to the chamber; presence within the chamber; movement of an animal relative to the litter device; or any combination thereof. The one or more emitting sensors may be located anywhere on, within, or near a litter device. One or more emitting sensors may include any sensor which emits and/or receives a type of wave (e.g., light beam, radio wave). One or more emitting sensors may include one or more laser sensors (e.g., time-of-flight sensors), infrared sensors, ultrasonic sensors, radio frequency (RF) admittance sensors, optical interface sensors, microwave sensors, the like, or combination thereof. It is also possible one or more membrane sensors may be used in lieu of or with one or more emitting sensors.

The one or more emitting sensors may be located within the interior and/or exterior of the litter device. Exemplary integration into a litter device may include affixed to a bezel, within a bezel, adjacent to an entry opening, above the entry opening, at a periphery of an entry opening, within a chamber, inside of a waste receptacle, affixed to a bonnet, the like, or any combination thereof. Suitable exemplary emitting sensors and configurations are disclosed in U.S. Pat. Nos. 11,399,502, and 11,523,586 and PCT Publication No.: WO 2024/196865, which are incorporated herein by reference in their entirety.

The one or more emitting sensors may be in communication with one or more controllers, computing devices, processors, communication modules, or any combination thereof. The one or more emitting sensors may be directly and/or indirectly connected to one or more controllers, computing devices, processors, communication modules, or any combination thereof. The one or more emitting sensors may relay one or more signals related to a monitored physical condition to one or more controllers, computing devices, processors, communication modules, or any combination thereof. The one or more emitting sensors may relay a presence of an animal, an absence of an animal, a distance to an animal, a distance to a litter bed, the presence waste, one or more positions or behavior of an animal, the like, or a combination thereof to one or more controllers, computing devices, processors, communication modules, or any combination thereof. A signal from one or more emitting sensors relayed to one or more controllers, computing devices, processors, communication modules, or any combination thereof related to the detected object may be referred to as a laser signal. The laser signal may be included as a status signal.

The one or more sensing devices may include one or more identification sensors (“ID sensor”). One or more ID sensors may function to identify an animal by its identity via one or more identifiers on an animal. An identification sensor may be one or more readers configured to communicate with one or more identifiers. An identification sensor may include a radio frequency identification (RFID) reader, Bluetooth® reader, a Near Field Communication (NFC) reader, the like, or any combination thereof. The one or more identification sensors may receive identification of an animal by collecting identifying data directly from the identifier, from receiving a signal related to identification data in an identification database, or both.

The one or more identification sensors may be located anywhere within, on, and/or near a litter device suitable for communicating with the identifier when an animal is near, at, or in the litter device. The one or more identification sensors may be located within an interior or exterior of the litter device. Exemplary integration into a litter device may include affixed to a bezel, inside of a bezel, within a chamber, affixed to a bonnet, within the base, affixed to the base, the like, or any combination thereof. The one or more identification sensors may be located between on a sensor mount, a rear cover, at the peripheral surface of an entry opening, between an entry opening and a waste drawer, beside a waste drawer, above a waste drawer, between an entry opening and a step, on a front of the base, the like, or any combination thereof.

The one or more identification sensors may be in communication with one or more controllers, computing devices, processors, communication modules, or any combination thereof. The one or more identification sensors may be directly and/or indirectly connected to one or more controllers, computing devices, processors, communication modules, or any combination thereof. The one or more identification sensors may relay one or more signals related an identifier to one or more controllers, computing devices, processors, communication modules, or any combination thereof. The one or more identification sensors may relay identifying data of an animal, data related to a subsequent database to retrieve identifying data of an animal, the like, or a combination thereof. A signal from one or more identification sensors relayed to one or more controllers, computing devices, processors, communication modules, or any combination thereof related to the detected identifier may be referred to as an identification signal. The identification signal may be included as a status signal.

An animal may be associated with an identifier. An identifier may function to specifically identify an animal. An identifier may be worn on a collar, embedded within the flesh (e.g., microchip), or the like. Exemplary identifiers may include radio frequency identification (RFID) tags, Bluetooth® tags, Near Field Communication (NFC) tags, passive IR, the like, or any combination thereof. One or more identifiers may have identification information stored therein, link to one or more databases which have identification information stored therein, or both. One or more identifiers may be active or passive. Passive may mean that the identifier is free of its own internal power source. Active may mean that the identifier is powered and/or broadcasts its own signal. An identifier may establish a signal with an identification sensor. This signal may be referred to as an identifier signal. An identifier signal may also be included as a status signal. Suitable exemplary identification sensor and identifiers are disclosed in PCT Publication Nos. WO 2022/087530 and WO 2024/196865, which are incorporated herein by reference in their entirety for all purposes.

The one or more sensing devices may include one or more cameras. The one or more cameras may be suitable for capturing one or more videos, images, frames, the like, or any combination thereof. The one or more cameras may be useful for visual recognition, identifying waste, capturing images and learning behaviors of the animal, the like, or any combination thereof. The one or more cameras may be positioned within a setting to have a line of sight on and/or into the litter device, an animal, waste, or a combination thereof. Line of sight may mean the camera is in view of at least part of or all of the front of a litter device, through an entry opening, into the interior chamber of a litter device, on an animal when using the litter device, on an animal when approaching the litter device, a litter bed, a septum, waste during a cleaning cycle, or any combination thereof. Line of sight may mean having an animal's body, side profile, front profile, rear profile, head, legs, eyes, nose, mouth, ears, tail or tail area, one or more bodily orifices, any combination thereof in view of the camera.

The one or more cameras may be located, affixed to, and/or part of a sensor mount, bezel, bonnet, base, adjacent to an entry opening, at or directly adjacent to a periphery of an entry opening, between an entry opening and/or bezel and a waste drawer, adjacent to a waste drawer, the like, or a combination thereof. The one or more cameras may be adjacent to one or more other sensing devices or distanced therefrom. The one or more cameras may be separate from the litter device and part of a system, connected via the network. Positioning near the top of a bezel and/or entry opening (e.g., near, part of sensor mount) may provide a clear line of sight into the interior of the chamber. This may be due to the tilted angle of the chamber, a tilt of the camera, or both. A line of sight into the interior may provide a clear line of sight onto a septum as a cleaning cycle is being executed. The clear line of sight may be able to capture images of waste after separation from a litter bed and prior to transferring into a waste receptacle. The location toward the upper portion of the bezel and/or entry opening may keep the camera clear of any waste, dust, or other debris associated with an animal using the litter device. The location on a front of the device, such as between an entry opening and a waste drawer may provide for a line of sight onto a face of an approaching animal, approximately at eye level. This may provide for better accuracy in visual recognition of the animal. Some suitable exemplary cameras and configurations are disclosed PCT Application No. PCT/US2024/020406 and PCT Publication No. WO 2022/087530, which are incorporated herein by reference in their entirety for all purposes.

The one or more cameras may be in communication with one or more controllers, computing devices, processors, communication modules, or any combination thereof. The one or more cameras may be directly and/or indirectly connected to one or more controllers, computing devices, processors, communication modules, or any combination thereof. The one or more cameras may relay one or more signals related an image and/or video stream to one or more controllers, computing devices, processors, communication modules, or any combination thereof. The one or more cameras may relay identifying data of an animal, data related to a subsequent database to retrieve identifying data of an animal, or both. A signal from one or more cameras relayed to one or more controllers, computing devices, processors, communication modules, or any combination thereof related to images and/or video may be referred to as an image signal. The image signal may be included as a status signal. The one or more cameras may be useful for providing visual recognition of the animal using the litter device.

System with Litter Device

The litter device may be integrated into a system. The system may allow for monitoring signals from, receiving signals from, sending signals to, and/or generating one or more operations of one or more litter devices. The system may allow for sending one or more instruction signals to a litter device. The system may allow for transmitting one or more signals, status signals, or both from the litter device. The system may allow for storing one or more data entries related to one or more signals. The system may allow for one or more algorithms to be executed remotely from the litter device. The system may allow for controlling of one or more operations of the litter device while remote from the device. The system may allow for a litter device to work together with other pet health devices (e.g., feeder, water dispenser, other litter devices, identification tags, cameras). The system may include one or more litter devices, one or more communication hubs, computing devices, processors, storage mediums, databases, one or more other pet health devices, the like, or any combination thereof.

The litter devices may be in communication with a communication hub. A communication hub may function to receive one or more signals, transfer one or more signals, or both from one or more litter devices, sensing devices, communication modules, controllers, processors, computing devices, the like, or any combination thereof. The communication hub may be any type of communication hub capable of sending and transmitting data signals over a network to one or a plurality of computing devices, compatible with one or more communication modules, or both. The communication hub may connect to one or more components of the system via one or more communication modules. The communication hub may include a wired router, a wireless router, an antenna, a satellite, or any combination thereof. For example, an antenna may include a cellular tower. For example, the communication hub may be in wireless connection with the litter device via the communication module. The communication hub may allow for communication of a computing device with the litter device when the computing device is directly connected to the communication hub, indirectly connected to the communication hub, or both. A direct connection to the communication hub may mean that the computing device is directly connected to the communication hub via a wired and/or wireless connection and communicates with the litter device through the communication hub. An indirect connection to the communication hub may mean that a computing device first communicates with one or more other computing devices via a network before transmitting and/or receive one or more signals to and/or from the communication hub and then to the litter device.

The litter device may be integrated into one or more networks. The litter device may be in removable communication with one or more networks. The one or more networks may be formed by placing the litter device in communication with one or more other computing devices. One or more networks may include one or more communication hubs, communication modules, computing devices, controllers, the like, or a combination thereof as part of the network. One or more networks may be free of one or more communication hubs. One or more computing devices of the system may be directly connected to one another without the use of a communication hub. For example, a communication module of a litter device may be placed in direct communication with a communication module of a mobile communication device (e.g., mobile phone) without having a communication hub therebetween. One or more networks may be connected to one or more other networks. One or more networks may include one or more local area networks (LAN), wide area networks (WAN), intranet, Internet, Internet of Things (IoT), the like, or any combination thereof. The network may allow for the litter device to be in communication with one or more user interfaces remote from the device via the Internet, such as through one or more managed cloud-computing services, edge-computing services, or both. An exemplary managed cloud service may include AWS IoT Core by Amazon Web Services®. An exemplary edge computing service may include FreeRTOS® provided by Amazon Web Services®. It is possible various networks and computing services may cooperate with one another (e.g., combination of edge computing and cloud computing). The network may be temporarily, semi-permanently, or permanently connected to one or more computing devices, litter devices, or both. A network may allow for one or more computing devices to be temporarily and/or permanently connected to the litter device to transmit one or more data signals to the litter device, receive one or more data signals from the litter device, or both. The network may allow for one or more signals from one or more controllers to be relayed through the system to one or more other computing devices, processors, storage mediums, the like, or any combination thereof. The network may allow for one or more computing devices to receive one or more data entries from and/or transmit one or more data entries to one or more storage mediums. The network may allow for transmission of one or more signals, status signals, data entries, instruction signals, or any combination thereof for processing by one or more processors.

The litter device may include and/or be in communication with one or more computing devices. The one or more computing devices may function to receive and/or transmit one or more signals, convert one or more signals to data entries, to send one or more data entries to a storage medium, to store one or more data entries, to retrieve one or more data entries from a storage medium, to compute and/or execute one or more algorithms and/or models, the like, or any combination thereof. One or more computing devices may include or be in communication with one or more other computing devices, processors, storage mediums, databases, interaction devices, pet health device(s), or any combination thereof. One or more computing devices may communicate with one or more computing devices, processors, storage mediums, databases, or any combination thereof through an interaction interface, dispatch interface, or both. Communication between computing devices may be controlled or managed via a managed cloud service, edge service, or both. The one or more computing devices may include one or more non-transitory storage mediums. A non-transitory storage medium may include one or more physical servers, virtual servers, or a combination of both. One or more servers may include one or more local servers, remote servers, or both. One or more computing devices may include one or more controllers (e.g., including processor) of litter device, one or more processors of sensing devices (e.g., including image processor), personal computing devices, or both. One or more personal computing devices may include one or more personal computers (e.g., laptop, desktop, etc.), one or more mobile computing devices (e.g., tablet, mobile phone, etc.), or both. One or more computing devices may use one or more processors.

One or more computing devices may include one or more processors. The one or more processors may function to analyze one or more signals from the litter device, one or more sensing devices, one or more storage mediums, databases, communication modules, the like, or any combination thereof. The one or more processors may be located within or be in communication with one or more computing devices, servers, storage mediums, or any combination thereof. One or more processors may be in communication with one or more other processors. The one or more processors may function to process data, execute one or more algorithms to analyze data, execute one or more algorithms to execute one or more operations of the litter device and/or generate one or more notifications, evaluate data against one or more rules, models, other data, the like, or any combination thereof. The one or more processors may automatically process data, execute one or more algorithms, evaluate data, or a combination thereof; may wait for an instruction or signal such as from a user; or any combination thereof. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, image processing units, the like, or any combination thereof. One or more software processors may include one or more word processors, document processors, the like, or any combination thereof. One or more system processors may include one or more information processors, the like, or a combination thereof. One or more processors suitable for use within the litter device as part of the one or more controllers may include a microcontroller, such as Part No. PIC18F45K22 and/or Part No. PIC18F46J50 produced by Microchip Technology Inc., incorporated herein by reference in their entirety for all purposes. The one or more processors may be located within a same or different non-transitory storage medium as one or more storage mediums, other processors, communication modules, communication hubs, or any combination thereof. The one or more processors may be an ARM-based processor. Exemplary ARM-based processors may include one or more of the Cortex-M Family, versions ARM to ARMv6 (ARM 32-bit), version ARMv6-M to ARMv9-R (ARM 32-bit Cortex), versions ARMv8-A to ARMv-9 (ARM 64/32-bit), the like, or any combination thereof. The one or more processors may include one or more image processors, artificial intelligence processors video processors, the like, or a combination thereof. An exemplary artificial intelligence processor may include the Ingenic T31 video processor, which is incorporated herein by reference for all purposes. The one or more processors may include one or more cloud-based processors. A cloud-based processor may be part of or be in communication with a dispatch interface, an interaction interface, an authentication portal, or a combination thereof. A cloud-based processor may be located remote from a litter device, a computing device, one or more other processors, one or more databases, or any combination thereof. Cloud-based may mean that the one or more processors may reside in a non-transitory storage medium located remote from the litter device, computing device, processor, databases, or any combination thereof. One or more cloud-based processors may be accessible via one or more networks. A suitable cloud-based processor may be Amazon Elastic Compute Cloud™ (EC2™) may be provided by Amazon Web Services®, incorporated herein by reference in its entirety for all purposes. Another suitable platform for a cloud-based processor may include Lambda™ provided by Amazon Web Services®, incorporated herein in its entirety by reference for all purposes. The one or more processors may convert data signals to data entries to be saved within one or more storage mediums. The one or more processors may access one or more algorithms to analyze one or more data entries and/or data signals. The one or more processors may access one or more algorithms to generate one or more operations of the litter device, generate one or more notifications to an application, or both. The one or more processors may access one or more algorithms saved within one or more storage mediums. The one or more algorithms being accessed by one or more processors may be located in a same or different storage medium or server as the processor(s).

One or more computing devices may include one or more storage mediums (“memory storage medium”). The one or more storage mediums may include one or more hard drives (e.g., hard drive memory), chips (e.g., Random Access Memory “RAM)”), discs, flash drives, memory cards, the like, or any combination thereof. The one or more storage mediums may include one or more cloud-based storage mediums, local storage mediums, or both. A local storage medium may be located onboard a litter device, sensing device, and/or the like. A local storage medium may be part of a circuit board. A cloud-based storage medium may be located remote from a litter device, a sensing device, a computing device, one or more processors, one or more databases, or any combination thereof. Cloud-based may mean that the one or more storage mediums may reside in a non-transitory storage medium located remote from the litter device, computing device, processor, other databases, or any combination thereof. One or more cloud-based storage mediums may be accessible via one or more networks. A suitable cloud-based storage medium may be Amazon S3™ provided by Amazon Web Services®, incorporated herein by reference in its entirety for all purposes. One or more storage mediums may store one or more data entries in a native format, foreign format, or both. One or more storage mediums may store data entries as objects, images, files, blocks, or a combination thereof. The one or more storage mediums may include one or more algorithms, models, rules, databases, data entries, the like, or any combination therefore stored therein. The one or more storage mediums may store data in the form of one or more databases.

One or more computing devices may include one or more databases. The one or more databases may function to receive, store, and/or allow for retrieval of one or more data entries. The one or more databases may be located within one or more storage mediums. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. The databases may be located within one or more non-transitory storage mediums. One or more databases may be located in a same or different non-transitory storage medium as one or more other databases. The one or more databases may be accessible by one or more processors to retrieve data entries for analysis via one or more algorithms. The one or more databases may be one or more cloud-based databases. Cloud-based may mean that the one or more databases may reside in a non-transitory storage medium located remote from the litter device. One or more cloud-based databases may be accessible via one or more networks. One or more databases may include one or more databases capable of storing one or more conditions of pet litter device, one or more status signals related to a litter device, one or more instruction signals sent to a litter device, one or more users, one or more user accounts, one or more registered pet health device(s), one or more traits and/or characteristics of one or more animals, one or more identifications of one or more animals, the like, or any combination thereof. The one or more databases may include one or more pet profile databases, visual recognition databases, user databases, user settings databases, commands databases, activities databases, behavior databases, device databases, lifetime cycles databases, user computing device databases, registered device databases, training databases, waste databases, the like, or a combination thereof. One or more waste databases may store one or more waste event records, associate one or more waste event records to one or more pet profiles, or both. One suitable database service may be Amazon DynamoDBR offered through Amazon Web Services®, incorporated herein in its entirety by reference for all purposes. One or more databases may include or be similar to those disclosed in U.S. Pat. No. 11,399,502 and PCT Application No. PCT/US2024/020406, which are incorporated herein by reference in their entirety for all purposes.

One or more computing devices may include one or more user interfaces. The one or more user interfaces may function to display information related to a litter device, display one or more notifications related to one or more animals, display information related to waste, receive user inputs related to a litter device, transmit information related to a litter device, or any combination thereof. The one or more user interfaces may be located on a litter device, a separate computing device, or both. One or more user interfaces may be part of one or more computing devices. One or more user interfaces may include one or more interfaces capable of relaying information (e.g., data entries) to a user, receiving information (e.g., data signals) from a user, or both. One or more user interfaces may display information related to a litter device. One or more user interfaces may display information from one or more algorithms. The user interface may allow for inputting of information related to a litter device. Information may include a username, password, one or more instruction signals, uploaded documents (e.g., veterinary documents), the like, or any combination thereof. The one or more user interfaces may include one or more graphic user interfaces (GUI). The one or more graphic interfaces may include one or more screens. The one or more screens may be a screen located directly on the litter device, another computing device, or both. The one or more screens may be a screen on a personal computing device (e.g., mobile computing device, personal computer). The one or more graphic interfaces may include and/or be in communication with one or more user input devices. The one or more user input devices may allow for receiving one or more inputs (e.g., instruction signals) from a user. The one or more input devices may include one or more buttons, wheels, keyboards, switches, touchscreens, the like, or any combination thereof. The one or more input devices may be integrated with a graphic interface. The one or more input devices may include one or more touch-sensitive monitor screens.

The system may include or be in communication with one or more applications. The application (i.e., “computer program”) may function to access data, upload data, receive data, receive instructions, transmit instructions, display information, transmit notifications, the like, or a combination thereof relative to a litter device, an animal, a waste, a computing device, other pet health devices, the like, or any combination thereof. The application may be stored on one or more storage mediums. The application may be stored on one or more personal computing devices, remote computing devices, or both. The application may be accessible by one or more personal computing devices while being executed from one or more remote computing devices. The application may comprise and/or access one or more computer-executable instructions, algorithms, rules, models, processes, methods, user interfaces, menus, databases, the like, or any combination thereof. The computer-executable instructions, when executed by a computing device, may cause the computing device to perform one or more methods described herein. The application may be downloaded, accessible without downloading, or both. The application may be downloadable onto one or more computing devices. The application may be downloadable from an application store (i.e., “app store”). An application store may include, but is not limited to, Apple App StoreR, Google PlayR, Amazon Appstore®, Skills Shop for Amazon's® Alexa®, the like, or any combination thereof. The application may be accessible without downloading onto one or more computing devices. The application may be accessible via one or more web browsers. The application may be accessible as a website. The application may interact and/or communicate through one or more user interfaces. The application may be utilized by and/or on one or more computing devices. The application may also be referred to as a dedicated application.

### Method for Identifying the Type of Waste Eliminated by an Animal in a Litter Device

The present teachings disclose a method for identifying the type of waste eliminated by an animal in a litter device. The method may employ the litter device as disclosed herein or even other types of automated litter devices.

The method may be understood as a computer-implemented method. The method may be in the form of one or more computer readable instructions. The method may be referred to as a waste identification method. The method may be stored on a computer-readable medium executable by a computing device. The method may be stored in one or more storage mediums. The one or more storage mediums may be local or remote from the litter device. The method may be accessible and/or executable by one or more processors. The method may be automatically executed. Each step may be automatically executed. Automatic execution may be by the one or more processors. The one or more processors may be part of one or more computing devices. The method may be executed locally, remotely, or both. The method may be executed by one or more controllers of a litter device, by edge-computing, cloud-computing, or a combination thereof.

The method disclosed herein may refer to a “waste event.” A waste event may be defined as each single use of an animal of the litter device. The waste event may include entering, eliminating waste, and/or exiting. A waste event may be free of eliminating waste if an animal enters and exits the litter device without urinating or defecating. A waste event may be the time period an animal is located within the litter device (e.g., in the chamber). A waste event may be the time period from when an animal enters the litter device to when the animal exits the litter device.

The method disclosed herein may refer to a “waste type.” A waste type may refer to a type of waste eliminated by an animal. A waste type may refer to urine, feces, or both.

While the teachings herein may refer to a cat, cat weight, or other terms specific to a cat, it can easily be envisioned that these teachings may be applied to any animal which may utilize a litter device. Thus, the term “cat” is typically not limiting to a cat, but to the broader meaning of an animal, unless explicitly stated otherwise. For example, the animal may be any domestic animal as discussed hereinbefore.

The method may include a litter device being in an idle state. In an idle state, one or more sensing devices detect one or more idle settings of a litter device between cleaning cycles. In the idle state, one or more sensing devices may continuously and/or intermittently monitor for entry of an animal into the chamber. One or more mass sensors may monitor for an increase in mass, indicating entry into a chamber. One or more emitting sensors may monitor to detect entry of an animal through the entry opening, presence of an animal in the chamber, or both. One or more cameras may monitor for detecting the visual presence of an animal passing through the entry opening, presence of the animal in the chamber, or both. One or more identification sensors may monitor for detecting one or more identifiers, indicating proximity of an animal to the litter device. One or more sensors may cooperate together to monitor for the presence and/or entry of an animal. In an idle state, one or more mass sensors may monitor the idle weight of the litter device as a whole, the chamber, the waste bin, or a combination thereof. In an idle state, one or more mass sensors may be tared to zero. One or more chamber mass sensors, waste bin mass sensors, or both may be tared to zero. By being tared to zero, the one or more chamber mass sensors detect the mass of the chamber (including components therein, such as septum and liner) and the litter at 0.0 lbs. By being tared to zero, the one or more waste bin mass sensors detect the mass of the waste bin, litter, and any already existing waste therein, at 0.0 lbs. It is also possible that one or more mass sensors are not tared to zero. In this instance, differential values between earlier and later weight readings may need to be determined.

The method may include one or more sensing devices detecting the presence of an animal in the chamber. One or more sensing devices may detect a change in a monitored condition indicating the presence of the animal. One or more sensing devices may transmit a signal relative to the changed condition to one or more processors which may then determine the presence of the animal. One or more mass sensors may detect an increased weight. One or more emitting sensors may have a laser beam interrupted. One or more cameras may detect an image and/or video indicating an animal. One or more identification sensors may detect an identifier. The one or more sensing devices may be configured to differentiate between an animal approaching the litter device, stepping on to the litter device out of curiosity, and/or an animal actually entering the chamber.

One or more sensing devices detecting the presence of an animal may include one or more mass sensors detecting the presence of the animal. One or more mass sensors may monitor for a weight change and/or weight. The mass sensors may monitor for a weight change, such as if not tared to zero during idle. The mass sensors may monitor for a weight, such as if tared to zero during idle. If tared to zero, the weight would be indicative of the weight change. Whether looking for a weight change or a weight, this value may be referred to as a cat weight. The one or more mass sensors may transmit the mass signal to one or more computing devices (e.g., local controller, remote server processor) which determine the presence of an animal by the monitored weight.

The one or more computing devices, mass sensors, or both may have a cat detection threshold stored therein. A cat detection threshold is a weight indicative of an animal, such as a cat, being fully located within the chamber. The cat weight is compared to the cat detection threshold. If the cat weight is greater than the cat detection threshold, it is determined that an animal (e.g., cat), is located inside of the chamber. If the cat weight is not greater than the cat detection threshold, it is determined that an animal is not located inside of the chamber. A cat detection threshold may be suitable for detecting a small animal (e.g., kitten). A cat detection threshold may be about 1 lb or greater, about 1.5 lbs or greater, about 2 lbs or greater, about 2.5 lbs or greater, or even about 3 lbs or greater. A cat detection threshold may be about 6 lbs or less, about 5 lbs or less, or even about 4 lbs or less. For example, a cat detection threshold may be about 2 to 3 lbs. A cat detection threshold may also include a time the mass is sensed. This time may aid in determining if an animal was just curious and approached the litter device or fully entered. The time may be about 1 second or greater, about 2 seconds or greater, about 3 seconds or greater, or even about 4 seconds or greater. The time may be about 10 seconds or less, about 7 seconds or less, or even about 6 seconds or less. For example, the time may be about 2 seconds to about 6 seconds. The one or more computing devices may continuously and/or intermittently monitor the incoming mass signal from the one or more mass sensors and compare to the cat detection threshold to determine the detected weight has increased to or above the cat detection threshold.

The method may include weighing the animal. Upon detection of the animal in the chamber, an animal weight may be captured. This weight may be useful by providing health insights to an owner (i.e., user) when accessible by an application. This weight may allow for identification of the animal based on their weight. The weight may be a peak weight, an average weight or other trend value, or other value(s) detected by, or determinable from, the one or more mass sensors. The one or more computing devices, mass sensors, or both may pinpoint the weight value to be used. The one or more computing devices may pinpoint the weight to be used based on the incoming mass signal from the one or more mass sensors. This weight may then be recognized as the cat weight. This cat weight may be used in the rest of the method as opposed to the initially detected cat weight for determining presence of the animal. It is also possible these weight values are one in the same.

The method may include identifying the animal. Identification of the animal may be beneficial in correlating a cat weight to an animal, correlating the waste activity to an animal, correlating a waste type to an animal, determining typical waste elimination trends of a specific animal, or any combination thereof. Identification may occur by any suitable means. Identification may occur with the aid of one or more sensing devices, with one or more computing devices, or both. Identification may utilize one or more attributes of the animal stored within or associated with one or more pet profiles. Identification may occur by one or more computing devices. Identification may be based on weight, visual recognition, detection of an identifier, the like, or any combination thereof. Weight-based identification may correlate the measured weight of the animal to an identification of an animal with a same or substantially similar weight. Weight-based identification may occur as disclosed in U.S. Provisional Patent Application No. 63/517,729 and PCT Publication No. WO 2025/034661, which are incorporated herein by reference in their entirety for all purposes. Visual recognition may correlate one or more images of the animal to an identification of an animal with substantially similar images. Identifier recognition may correlate an identifier of the animal to an identification of an animal associated with the same identifier. Visual recognition and identifier recognition may occur as disclosed in PCT Patent Application No. PCT/US2024/020406 and PCT Publication No. WO 2024/196865, which are incorporated herein by reference in their entirety for all purposes.

The method may include pairing the identification of the animal with the cat weight. Once the identity of an animal is determined, the cat weight may be paired or otherwise correlated with the identity of the animal. This may allow for the weight and any activity related to the usage of the litter device by the animal to be correlated with a specific animal. The pairing may be temporarily or permanently stored in one or more databases. The pairing may be executed by one or more computing devices. The pairing may be stored in one or more pet profile databases or similar. The pairing may include storing the cat weight in a pet profile or associating with a specific pet profile.

The method may be free of identifying an animal. The method may be free of pairing the identification of the animal with the cat weight. It is foreseeable that in some instances, such as single pet households, there is no need to identify the pet. In these circumstances there is only a single possibility of what animal uses the litter device and whose weight and activities are registered.

The method may include one or more sensing devices detecting the departure of the animal from the chamber. One or more sensing devices may detect a change in a monitored condition indicating the departure of the animal. One or more computing devices may detect a change in an incoming signal from one or more sensing devices. One or more sensing devices may transmit a signal relative to a changed condition to one or more processors which determine the departure of the animal. One or more mass sensors may detect a decreased weight. One or more emitting sensors may have a laser beam interrupted or no longer interrupted. One or more cameras may detect an image and/or video indicating the departure of the animal. One or more identification sensors may lose connection with an identifier. Once it is determined the animal has departed the chamber, a cleaning cycle timer may commence.

The one or more computing devices, mass sensors, or both thereof may have a cat detection hysteresis threshold stored therein. The cat detection hysteresis threshold may be a weight indicative that an animal is no longer fully located within the chamber. Once a cat is detected, the one or more mass sensors monitor for the cat weight to drop below the cat detection hysteresis threshold. Once the cat weight drops below the cat detection hysteresis threshold, it is determined the animal has left the chamber. The one or more sensing devices may monitor for the cat weight to drop below the cat detection hysteresis threshold continuously or intermittently after the cat weight exceeds the cat detection threshold. The one or more computing devices may continuously and/or intermittently monitor the incoming mass signal from the one or more mass sensors and compare to the cat detection hysteresis threshold to determine the detected weight has dropped below the cat detection hysteresis threshold.

The method may include initiating a cleaning cycle timer. A cleaning cycle timer may provide a default time period between an animal departing the chamber and a cleaning cycle initiating. This cleaning cycle timer may intentionally create a waiting period between an animal departing the chamber and a cleaning cycle initiating. The cleaning cycle timer may be useful in allowing clumping litter sufficient time to set and stick to urine, allow a cleaning cycle to be initiated before too much odor causing bacteria builds up in the chamber, allow the same or another animal to reenter the litter device to eliminate waste, the like, or any combination thereof. The cleaning cycle timer may be set at 30 seconds or more, 1 minute or more, 3 minutes or more, 5 minutes or more, or even 7 minutes or more. The cleaning cycle timer may be set at 1 hour or less, 45 minutes or less, or even 30 minutes or less.

The method may include generating a waste event count. The waste event counts may function to identify the number of waste events occurring before a cleaning cycle is executed, identifying multiple uses of the litter device by one or more animals between cleaning cycles, or both. A waste event count may be reset to zero after a cleaning cycle. Once the presence of an animal is detected, the departure of an animal is detected, and/or a cleaning cycle timer is initiated, the waste event count may be increased by an increment of one. This incremental value of one may mean that one animal has used the litter device for a waste event. A waste event count may be generated by the one or more computing devices. A waste event count may be stored within one or more storage mediums.

The method may include generating a waste event record. The waste event record may function to include and/or collect one or more values associated with the waste event. The waste event record may be automatically created upon entry of the animal into the chamber, upon departure of the animal from the chamber, a cleaning cycle timer commencing, a waste event count being generated, the like, or a combination thereof. The waste event record may be generated by one or more computing devices. When generated, the waste event record may include the cat weight, animal identity, waste event count, date, time(s), or a combination thereof. This information may all be provided as data values part of the waste event record. It is also possible that some of these values may be later appended to the waste event record. The waste event record may be stored within one or more storage mediums. The waste event record may be stored within a waste event database. The waste event record may be associated with a pet profile database, other database, pet identifier, and/or other data such as to associate the waste event record with the identity of a specific animal.

The method may include determining a waste deposit weight in a chamber. A waste deposit weight in a chamber may function to aid in identifying the presence of waste in the chamber, the type of waste in the chamber, or both. The waste deposit weight in the chamber may be the weight change detected by one or more chamber mass sensors, litter device mass sensors, or both. One or more computing devices may determine the weight change based on an incoming mass signal from one or more mass sensors. The weight change may be the difference in the weight when in the idle state to immediately after departure of the animal. The weight change may be the weight identified by the one or more mass sensors if tared to zero during the idle state.

The method may include assigning the waste deposit weight in the chamber to the waste event record. This may allow for the waste deposit weight to be correlated to a specific waste event, animal identity, or both. This may allow for the waste deposit weight to be used by one or more waste type identification algorithms. The waste deposit weight in the chamber may be provided as a data value part of the waste event record. One or more computing devices may transmit the waste deposit weight to the waste event record.

The method may include determining if the waste deposit weight indicates the presence of waste in the chamber. The waste deposit weight may function to confirm if the animal eliminated waste in the chamber when present in the chamber. There are times an animal may enter the chamber out of curiosity, to dig into the litter bed, to seek shelter, the like, or a combination thereof. Thus, when the animal departs the litter device, the weight of the litter device and/or chamber returns back to a substantially same weight as during the idle state. The waste deposit weight in the chamber is compared to a minimum waste detection threshold. A waste detection threshold may be set at an expected minimum weight increase if waste is deposited in the litter device. If the waste deposit weight in the chamber is less than the minimum waste detection threshold, it may be automatically determined that no waste was eliminated. In this case, the cleaning cycle time may be cancelled (e.g., if already initiated) or not initiated. In this case, the waste event record may be automatically disposed of, not stored, updated to indicate no waste, or any combination thereof. If the waste deposit weight in the chamber is equal to or greater than the minimum waste detection threshold, it may be automatically determined that waste was eliminated by the animal. In this case, the waste event record may be automatically transmitted to and stored within a storage medium. The determining may be executed by one or more computing devices.

The method may include identifying a waste type before a cleaning cycle is initiated. The waste deposit weight in the chamber (e.g., waste weight) may be correlated to a waste type. Identifying the waste type before a cleaning cycle may be useful in the instance where multiple animals use the litter device between cleaning cycles. As in this manner, the incremental increase in waste can be correlated to a specific animal's entry and exit from the device. If multiple animals use the litter device between cleaning cycles, after a cleaning cycle, all of the waste may transfer together into a waste receptacle such that the waste type cannot be determined. Identifying the waste type before a cleaning cycle is executed may be useful in automatically adjusting a cleaning cycle timer based on the type of waste. Identifying the waste type with a pre-cleaning cycle method may function in addition to one or more post cleaning cycle identification means or as an alternative identification means. Identifying a waste type before a cleaning cycle is initiated may include identifying the waste type by identifying the waste type by waste weight before a cleaning cycle. Identifying a waste type before a cleaning cycle may include executing one or more waste type identification algorithms. Identifying a waste type before a cleaning cycle may include executing a pre-sift chamber weight algorithm.

The method may be free of identifying the waste type before the cleaning cycle is initiated.

The method may include modifying a cleaning cycle timer. A cleaning cycle timer may be automatically adjusted based on the waste type identified. A default time period of the cleaning cycle timer may be automatically adjusted. A default time period may be optimized for urine, such as to allow for clumping with litter. If the waste type is identified as feces, the default time period may be reduced, the cleaning cycle timer may be forced to completion, or both. As feces builds up an odor in the chamber quicker than urine and may not require a similar clumping time with litter to allow for being filtered from clean litter, it can be advantageous to quickly execute a cleaning cycle when feces is identified. If the waste type is identified as feces, the cleaning cycle timer may be automatically ended (e.g., expired) and a cleaning cycle may be executed. One or more computing devices may automatically modify the cleaning cycle timer.

The method may include executing a cleaning cycle. The cleaning cycle may function to automatically segregate waste from the litter, transfer waste from a chamber, transfer waste to a waste bin or other waste receptacle, or a combination thereof. A cleaning cycle may function to sort clean litter (e.g., unused litter) from waste, used litter, clumps, lumps, or any combination thereof. A cleaning cycle may be automatically initiated when a cleaning cycle timer expires. A cleaning cycle may be automatically initiated by one or more computing devices (e.g., processor, controller). During a cleaning cycle, a chamber may be rotated, a septum may sift through the litter, or both. During a cleaning cycle, a chamber may remain stationary while a septum is rotated therein to sift through the litter. During a cleaning cycle, a chamber may remain stationary while a scoop is moved axially therein to sift through the litter. A cleaning cycle may occur as disclosed in PCT Publication No.: WO 2020/219849 and WO 2023/212686, which are incorporated herein by reference in their entirety for all purposes.

The method may include monitoring for one or more animals during the cleaning cycle timer and/or cleaning cycle. Monitoring for one or more animals during a cleaning cycle may function to prevent movement of the chamber, septum, or any portions thereof while an animal tries to enter, or does enter, the litter device, thus reducing any safety risks of having the animal interacting with any movement components. One or more sensing devices may function to monitor for one or more animals during the cleaning cycle. One or more sensing devices may detect a change in a monitored condition indicating the presence of the animal. One or more sensing devices may transmit a signal relative to the changed condition to one or more computing devices (e.g., processors) which determine the presence of the animal. One or more sensors may detect an increased weight. One or more emitting sensors may have a laser beam interrupted. One or more cameras may detect an image and/or video indicating an animal. One or more identification sensors may detect an identifier. The one or more sensing devices may be configured to differentiate between an animal approaching the litter device, stepping on the litter device out of curiosity, and actually entering the chamber. One or more mass sensors may monitor for a weight change or weight. The mass sensors may monitor for a weight change, such as if not tared to zero during idle or if the weight reading is above zero due to waste having been previously eliminated in the chamber. This weight value may be referred to as a cat weight. The one or more mass sensors may transmit the mass signal to one or more controllers to determine the presence of an animal by the monitored weight. The one or more controllers, mass sensors, or both may have a cat detection threshold stored therein. A cat detection threshold is a weight indicative of an animal, such as a cat, being fully located within the chamber. The cat weight is compared to the cat detection threshold. If the cat weight is greater than the cat detection threshold, it is determined that an animal (e.g., cat), is located inside of the chamber. If it is determined that an animal is inside of the chamber, the cleaning cycle is automatically stopped.

The method may include stopping a cleaning cycle timer and/or cleaning cycle if an animal is detected in the litter device. The stopping of the cleaning cycle may function to allow the newly detected animal to continue to use the litter device, eliminate waste comfortably, exit the litter device, provide a safe condition for the animal in the litter device, or a combination thereof. The stopping may be executed by one or more computing devices. Once the cleaning cycle is stopped, the method may repeat a number of steps until the animal exits the chamber. The method may include repeating the steps of: weighing the animal, identifying the animal, pairing the identification of the animal with the cat weight, one or more sensing devices detecting the departure of the animal from the chamber, generating a waste event count, generating a waste event record, determining a waste deposit weight in a chamber, assigning the waste deposit weight in the chamber to the waste event record, determining if the waste deposit weight indicates the presence of waste in the chamber, executing a cleaning cycle, monitoring for one or more animals during the cleaning cycle, or a combination thereof. If it is determined that an animal is inside of the chamber, the method may include increasing the event count. The event count may be the number of times an animal has used the litter device between cleaning cycles being executed and completed. If the one or more mass sensors are tared at the start of the process, differences in weight values may be utilized for repeating method steps as opposed to actual readings. This may be useful as the waste was not disposed of due to the stopping a cleaning cycle and the waste not transferring from the litter device before the animal entered the litter device.

The method may include identifying a waste type after a cleaning cycle is completed. The waste, once transferred from the chamber to a waste receptacle, may have one or more properties which can be automatically sensed to determine a waste type. The litter in a chamber may have one or more properties which can be automatically sensed to determine a waste type. The waste deposit weight in a waste receptacle (e.g., waste weight) may be correlated to a waste type. The litter weight in a chamber (e.g., chamber weight) may be correlated to a waste type. Identifying a waste type after a cleaning cycle is completed may include identifying the waste type by a waste bin weight, identifying the waste type by a chamber weight, or a combination thereof. Identifying a waste type after a cleaning cycle may include executing one or more waste type identification algorithms. Identifying a waste type after a cleaning cycle may include executing a post-sift waste bin weight algorithm, post-sift waste bin weight change algorithm, post-sift chamber weight algorithm, the like, or a combination thereof. It is also possible that identifying a waste type after a cleaning cycle is completed may include executing any of the same waste type identification algorithms as feasible for identifying a waste type before a cleaning cycle is initiated and/or while a cleaning cycle is running. This may function to cross-reference waste type findings and check for accuracy. The identified weight data may be retrieved after the cleaning cycle and used to execute a pre-sift chamber weight algorithm. A pre-sift chamber weight algorithm may be executed before the cleaning cycle while a post-sift cleaning algorithm may be executed after the cleaning cycle with results compared to one another.

The method may be free of identifying a waste type after a cleaning cycle is completed.

The method may include both identifying a waste type before a cleaning cycle is completed and after a cleaning cycle is completed. The method may only include identifying a waste type before a cleaning cycle. The method may only include identifying a waste type after a cleaning cycle.

The method may include resetting the waste event count. The waste event count may be set to zero to indicate a cleaning cycle has been executed, allow for an optimal waste type identification algorithm to be selected, or both. The waste event count may be automatically reset to zero by one or more computing devices, such as the controller.

The method may include updating an application to display data of a waste event record to a user via a user interface. Upon a waste event and waste type being identified, a waste event record being completed, a cleaning cycle being completed, an animal departing the litter device, or a combination thereof, one or more portions (e.g., data entries) of the waste event record may be transmitted to an application. Via the application, a user may be able to see a history of waste events and associated waste types of one or more animals and one or more litter devices.

The method may include comparing results of one or more of the waste type identification algorithms with results from one or more of the other waste type identification algorithms. Based on the comparison, a more accurate result may be the one stored, an algorithm may be trained, the like, or any combination thereof.

### Waste Type Identification Algorithms

The method disclosed herein may utilize one or more algorithms. The one or more algorithms may function to correlate one or more sensed conditions to a waste type. The one or more algorithms may be referred to as one or more waste type identification algorithms. The one or more algorithms may be automatically executed as part of the method for identifying the type of waste eliminated by an animal in a litter device. The one or more algorithms may be executed upon departure of an animal from the litter device, upon a cleaning cycle timer being initiated, while the cleaning cycle timer is running, while a cleaning cycle is running, after a cleaning cycle is completed, the like, or a combination thereof. One or more waste type identification algorithms may include one or more pre-sift chamber weight algorithms, post-sift waste bin weight algorithms, post-sift waste bin weight change algorithms, post-sift chamber weight algorithms, the like, or a combination thereof.

One or more waste type identification algorithms may be part of or accessible by the method for identifying the type of waste eliminated by an animal in a litter device. One or more waste type identification algorithms may be in the form of one or more computer readable instructions, stored on one or more computer readable mediums, or both. One or more waste type identification algorithms may be accessible and/or executable by one or more processors. The one or more processors may be part of one or more computing devices. The method may be executed locally, remotely, or both. The method may be executed by one or more controllers of a litter device, by edge-computing, cloud-computing, or a combination thereof. One or more processors may execute each step of the algorithm. Measured data, sensed data, derived data (e.g., determined or calculated as part of the method or algorithm), or a combination thereof may be stored within one or more storage mediums, in one or more records, or both.

### Pre-Sift Chamber Weight Algorithm

An algorithm may include a pre-sift chamber weight algorithm. A pre-sift chamber weight algorithm may be useful in identifying a waste type by waste weight before a cleaning cycle. A pre-sift chamber weight algorithm may function to correlate the change in weight in a litter chamber from before use by an animal to immediately after use by the animal or before a cleaning cycle is executed, between one animal using and another animal, or both to a waste type. The weight of the waste itself may be indicative of the waste type. For some animals, urine deposits may be heavier than fecal deposits. Each animal may have different ratios of their urine weight as compared to their feces weight. After an animal has departed the chamber, one or more mass sensors may detect the weight of the chamber or the litter device as a whole. This weight may be indicative of the weight of the waste deposited by the animal. If the one or more mass sensors were tared to zero, the weight of the waste may be the weight detected. If the one or more mass sensors are not tared to zero, or already detect additional weight, then the weight may be a weight difference compared to a reading prior to entry of the animal. If there are multiple entries and exits of an animal detected between cleaning cycles, the weight difference from one animal exiting to the next animal exiting may be the weight of the waste.

The pre-sift chamber weight algorithm may first determine a waste weight. A waste weight may be the weight change in chamber weight, litter device weight, or both. The waste weight may be the same as the waste deposit weight as discussed hereinbefore relative to the method as a whole. The weight change may be relative to the weight during an idle state, prior to animal entry, or both as compared to after an animal exiting the chamber, prior to execution of the cleaning cycle, while a cleaning cycle timer is running, or a combination thereof. The waste weight may be the weight detected by the one or more mass sensors. The one or more mass sensors may be one or more device mass sensors, chamber mass sensors, or both.

The pre-sift chamber weight algorithm may compare the waste weight to one or more weight comparison values. By comparing the waste weight to one or more comparison values, the waste type may be determined. It has been found that typically a cat's urine deposit weighs about 1.25 to 1.75 (e.g., about 1.5) times more than a fecal deposit. Comparison values for a specific animal's typical waste habits can be found as discussed later on in this disclosure. Comparing to one or more weight comparison values may include comparing to one or more trend values. One or more trend values may include a lower limit, upper limit, means, median, mode, and/or the like.

The pre-sift chamber weight algorithm may compare the waste weight to a lower limit. If the waste weight is greater than the lower limit, the waste weight may be identified as a first waste type. The first waste type may be urine. The waste type may be assigned to the associated waste record. If the waste weight is not greater than the lower limit, the waste weight may be compared to an upper limit.

The pre-sift chamber weight algorithm may compare the waste weight to an upper limit. If the waste weight is less than the upper limit, and also less than the lower limit, the waste weight may be identified as a second waste type. A second waste type may be feces. The waste type may be assigned to the associated waste record. If the waste weight is above the upper limit, that may be indicative of an abnormality and either not assigned any waste type, or instead assigned based on closest proximity to a trending weight value specific to a waste type.

The pre-sift chamber weight algorithm may include automatically adding the waste type detection to a waste event record. Once a determination is made of the waste type from the comparing, the computing device may automatically update the waste event record to associate the detected waste type with the waste event.

The pre-sift chamber weight algorithm may include initiating a cleaning cycle before the cleaning cycle timer initiates the cleaning cycle. The pre-sift chamber weight algorithm may include initiating a cleaning cycle if a certain waste type is detected. As discussed above, one waste type over another may be more odorous. The pre-sift chamber weight algorithm may include initiating a cleaning cycle if a feces waste type is detected. The pre-sift chamber weight algorithm may include overriding a cleaning cycle timer, cancelling a cleaning cycle timer, or both. This may allow for a cleaning cycle to quickly remove more pungent waste from a chamber without needing to wait for the cleaning cycle timer to run its course or manual initiating of the cleaning cycle by a user.

### Post-Sift Waste Bin Weight Algorithm

An algorithm may include a post-sift waste bin weight algorithm. A post-sift waste bin weight algorithm may function to correlate the change in weight in a waste bin from before a cleaning cycle to after a cleaning cycle to a waste type. Once the waste is transferred into the waste receptacle after a cleaning cycle, one or more sensing devices may be able to sense one or more properties of the waste and/or waste receptacle indicative of the waste type.

The post-sift waste bin weight algorithm may first determine a waste weight. A waste weight may be the weight change in a waste bin. The weight change may be relative to the weight during an idle state, prior to animal entry, prior to a cleaning cycle, or any combination thereof as compared to after a cleaning cycle being executed. In other words, the waste weight is the increase in weight once waste is deposited into the waste bin after a cleaning cycle. The waste weight may be the weight detected by one or more mass sensors. The one or more mass sensors may be one or more waste bin mass sensors. One or more device mass sensors may not be suitable as they may not detect a change in weight when the waste is shifting from one location (e.g., chamber) to another (e.g., waste bin) during a cleaning cycle.

The post-sift waste bin weight algorithm may compare the waste weight to a minimum detection threshold. The minimum detection threshold may function to identify if any waste was deposited and transferred or if an animal entered and exited the chamber without eliminating any ways. If the waste weight is less than the minimum detection threshold, it is determined that no waste was eliminated by the animal. In other words, no urine or feces was transferred into the waste bin such as to increase the weight of the waste bin. If the waste weight is less than the minimum detection threshold, the waste event record is updated to include that no waste was deposited, the waste event record is deleted, or both. If the waste weight is greater than the minimum detection threshold, the algorithm automatically stores the waste weight as part of the waste event record. If the waste weight is greater than the minimum detection threshold, the post-sift waste bin weight algorithm moves onto comparing to one or more comparison values.

The post-sift waste bin weight algorithm may compare the waste weight to one or more weight comparison values. By comparing the waste weight to one or more comparison values, the waste type may be determined. As discussed hereinbefore, not only has it been found that a cat's urine deposit weighs more than a fecal deposit, but urine also collects a significant amount of litter, and its associated weight, through the clumping of the litter with the urine. Typically, once removed from a litter bed, a cat's urine deposit weighs about 1.25 to 4, or even about 1.5 to 2 times as much as a fecal deposit. Comparison values for a specific animal's typical waste habits are discussed later on in this disclosure. Comparing to one or more weight comparison values may include comparing to one or more trend values. One or more trend values may include a lower limit, upper limit, means, median, mode, and/or the like.

The post-sift waste bin weight algorithm may compare the waste weight to a lower limit. If the waste weight is greater than the lower limit, the waste weight may be identified as a first waste type. The first waste type may be urine. The waste type may be assigned to the associated waste record. If the waste weight is not greater than the lower limit, the waste weight may be compared to an upper limit.

The post-sift waste bin weight algorithm may compare the waste weight an upper limit. If the waste weight is less than the upper limit, and also less than the lower limit, the waste weight may be identified as a second waste type. A second waste type may be feces. The waste type may be assigned to the associated waste record. If the waste weight is above the upper limit, that may be indicative of an abnormality and either not assigned any waste type, or instead assigned based on closest proximity to a trending weight value specific to a waste type.

The post-sift waste bin weight algorithm may include comparing the post-sift waste weight to the pre-sift waste weight. This may be useful in determining a typical amount of litter collected by the urine and/or feces, determining how much of the waste was transferred into the waste bin during a cleaning cycle, verifying the waste type determination, or a combination thereof. For example, the waste weight of the chamber, such as found by the pre-sift chamber waste weight algorithm, may be compared to the waste weight of the waste bin found by the post-sift waste bin algorithm.

The post-sift waste bin weight algorithm may include automatically adding the waste type detection to a waste event record. Once a determination is made of the waste type from the comparing, the computing device may automatically update the waste event record to associate the detected waste type with the waste event.

### Post-Sift Waste Bin Weight Change Algorithm

An algorithm may include a post-sift waste bin weight change algorithm. A post-sift waste bin weight change algorithm may function to correlate a percent change in weight of the waste bin from one cleaning cycle to the next with a waste type. This may be useful as an animal may typically eliminate urine having a weight in close proximity to prior urinating events, feces having a weight in close proximity to prior fecal events, or both. In other words, the weight of one urine event may be fairly similar to the weight of a previous urine event, while the weight of one urine event is substantially different to the weight of a previous fecal event. And similar, the weight of one fecal event is substantially different compared to a previous urine event.

The post-sift waste bin weight change algorithm may first determine a waste weight. A waste weight may be the weight change in a waste bin. The weight change may be relative to the weight during an idle state, prior to animal entry, prior to a cleaning cycle, or any combination thereof as compared to after a cleaning cycle being executed. In other words, the waste weight is the increase in weight once waste is deposited into the waste bin after a cleaning cycle. The waste weight may be the weight detected by one or more mass sensors. The one or more mass sensors may be one or more waste bin mass sensors. One or more device mass sensors may not be suitable as they may not detect a change in weight when the waste is shifting from one location (e.g., chamber) to another (e.g., waste bin) during a cleaning cycle.

The post-sift waste bin weight change algorithm may retrieve a prior waste weight. A prior waste weight may be the weight change in a waste bin after the a previous (e.g., immediately previous) cleaning cycle. The weight change may be relative to the weight during an idle state, prior to animal entry, or both as compared to after a cleaning cycle being executed. In other words, the waste weight is the increase in weight when waste is deposited into the waste bin after a cleaning cycle. The prior waste weight may be obtained from the previously occurring waste event record, from the waste event database, or both.

The post-sift waste bin weight change algorithm may compare the current waste weight and the prior waste weight to a rate of change threshold. The rate of change threshold may be indicative of the rate of change between a present and previous waste weight being associated with urine or feces.

The comparison may first include comparing a rate of change to a positive rate of change threshold. The comparison may include finding the difference between the current waste weight and the prior waste weight. The comparison may include dividing the difference by the prior waste weight. This may provide a first rate of change. If the first rate of change is greater than the positive rate of change threshold, the current waste weight may be indicative that the waste type is urine. The waste type of urine may then be assigned to the waste event record. If the first rate of change is not greater than the positive rate of change threshold, then the comparison may include comparing a rate of change to a negative rate of change threshold.

The comparison may include comparing a rate of change to a negative rate of change threshold. The comparison may include finding the difference between the current waste weight and the prior waste weight. The comparison may include dividing the difference by the current waste weight. This may provide a second rate of change. If the second rate of change is less than the negative rate of change threshold, the current waste weight may be indicative that the waste type is feces. The waste type of feces may then be assigned to the waste event record. If the rate of change is not less than the negative rate of change threshold, the current waste weight is indicative that the waste is the same type of waste as the prior waste. In other words, if urine was found as the waste type in the previous cycle, then this waste type is also urine, and if feces was found as the waste type in the previous cycle, then this waste type is also feces. This is due to the two consecutive waste rates being in close proximity to one another due to being associated with the same waste type. The same waste type of the prior waste is assigned to the waste event record of the current waste.

The post-sift waste bin weight algorithm may include automatically adding the waste type detection to a waste event record. Once a determination is made of the waste type from the comparing, the computing device may automatically update the waste event record to associate the detected waste type with the waste event.

### Post-Sift Chamber Weight Algorithm

An algorithm may include a post-sift chamber bin weight algorithm. A post-sift chamber weight algorithm may be useful in identifying a waste type by litter weight (e.g., chamber wight) after a cleaning cycle. A post-sift chamber weight algorithm may function to correlate the change in weight in a chamber from before entry of an animal to after a cleaning cycle to a waste type. The weight change of a chamber, due to the litter bed therein, may be indicative of a waste type. Most litter box users choose to use clumping litter. Clumping litter works well with both manual and automated sifting by sticking to urine to form clumps and allow for easy separation from unused litter. Clumping litter works by contacting and absorbing moisture from urine and/or feces. As urine has a greater amount of moisture than feces, a greater amount of litter sticks and clumps with urine as compared to feces. This means that a larger weight of litter sticks to urine as compared to feces. This also means that during a cleaning cycle, a larger amount and weight of litter is removed from the chamber when clumps of urine are removed from a cleaning cycle as compared to feces. This results that when urine is removed, the chamber weight is substantially reduced as compared to prior to entry and use by the animal, and when feces is removed, the chamber weight is minimally reduced as compare to prior to entry and use by the animal.

The post-sift chamber weight algorithm may first determine a chamber weight. A chamber weight may be the weight change in chamber weight. The weight change may be relative to the weight during an idle state, prior to animal entry, or both as compared to after a cleaning cycle is executed. In other words, the comparison of the chamber weight before use by an animal and the chamber weight after execution of a cleaning cycle. The chamber weight may be the weight detected by the one or more mass sensors. The one or more mass sensors may be one or more chamber mass sensors.

The post-sift chamber weight algorithm may compare the chamber weight to minimum detection threshold. The minimum detection threshold may function to identify what type of waste was removed from the chamber during the cleaning cycle which occurred immediately prior. The minimum detection threshold may be a comparison chamber weight value, a negative value, or both. The minimum detection threshold may be a negative value of the typical weight of the chamber after a cleaning cycle which only removes feces. If during the comparison, the chamber weight is less than the minimum detection threshold, a first waste type is associated with the chamber weight. The first waste type may be urine. If during the comparison, the chamber weight is not less than the minimum detection threshold, a second waste type is associated with the chamber weight. The second waste type may be feces. The waste type once determined may be assigned to the waste event record.

The post-sift chamber weight algorithm may include automatically adding the waste type detection to a waste event record. Once a determination is made of the waste type from the comparing, the computing device may automatically update the waste event record to associate the detected waste type with the waste event.

### Comparison Values Used by Waste Type Identification Algorithm(s)

One or more waste type identification algorithms may utilize one or more comparison values. One or more comparison values may be one or more pre-established values, one or more trend values associated with waste habits of an animal and/or device, or any combination thereof. One or more comparison values may remain static, may continuously update with use of a litter device, or both. One or more comparison values may include one or more pre-established values. One or more pre-established values may be static values which are predetermined. One or more pre-established values may be based on one or more characteristics of an animal (e.g., age, weight, breed, gender). One or more pre-established values may be one or more trend values derived from one or more larger databases. One or more comparison values may be moving trend values. The moving trend period may be over a number of uses of a device, number of uses of one or more devices by a specific animal, a set time period, the like, or any combination thereof.

One or more trend values may include one or more upper limits, lower limits, medians, modes, means, the like, or a combination thereof. The one or more trend values may be determined employing typical statistical methods.

One or more trend values may be found for one or both types of waste. For example, upper and lower limits associated with urine may be determined. Feces may be determined as typically being either below the lower limit or above the upper limit. As another example, upper and lower limits associated with both urine and feces may be determined.

One or more comparison values may be determined via one or more standard statistical methods, via one or more machine learning algorithms, or both. One or more comparison values may be identified relative to urine, feces, absence of waste, or a combination thereof. One or more clusters of data associated with urine, feces, and/or waste absence may be found.

One or more comparison values may even include or determine specific waste elimination behaviors of an animal. For example, the total number of times an animal is expected to eliminate waste per day, the total number of times an animal eliminates urine per day, the total number of times an animal eliminates feces per day, or a combination thereof. One or more comparison values may even include typical times of day an animal may eliminate feces, urine, or both. The specific patterns of an individual animal may be employed with the other comparison values and in the waste identification algorithms.

### Illustrative Examples

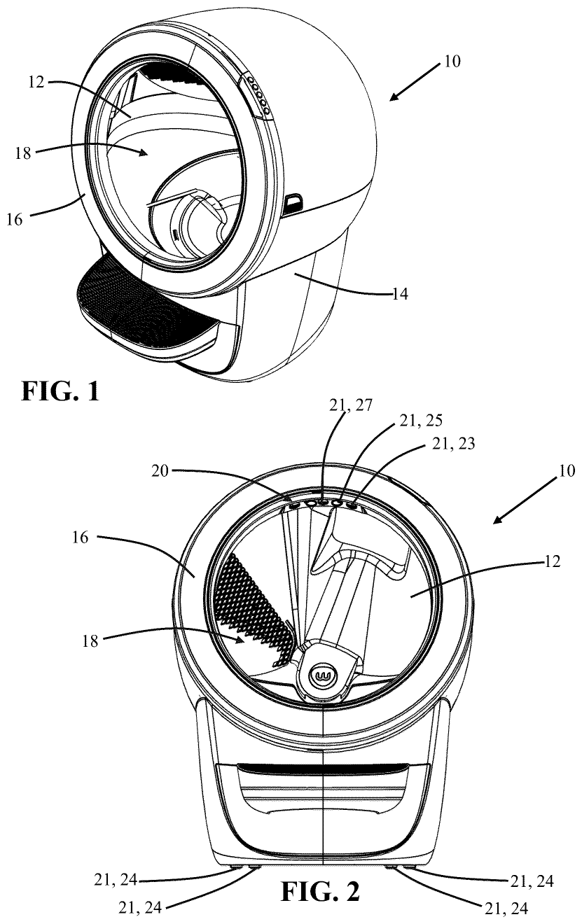

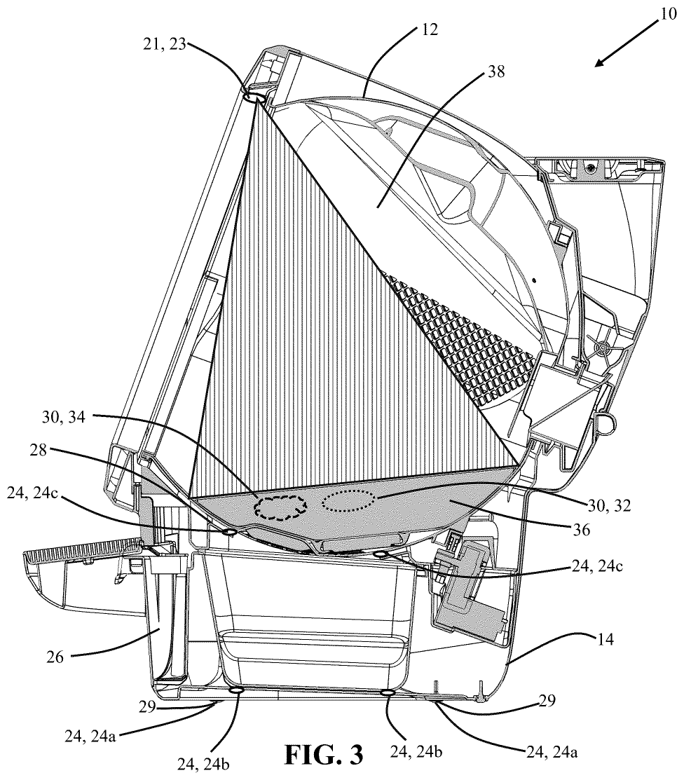

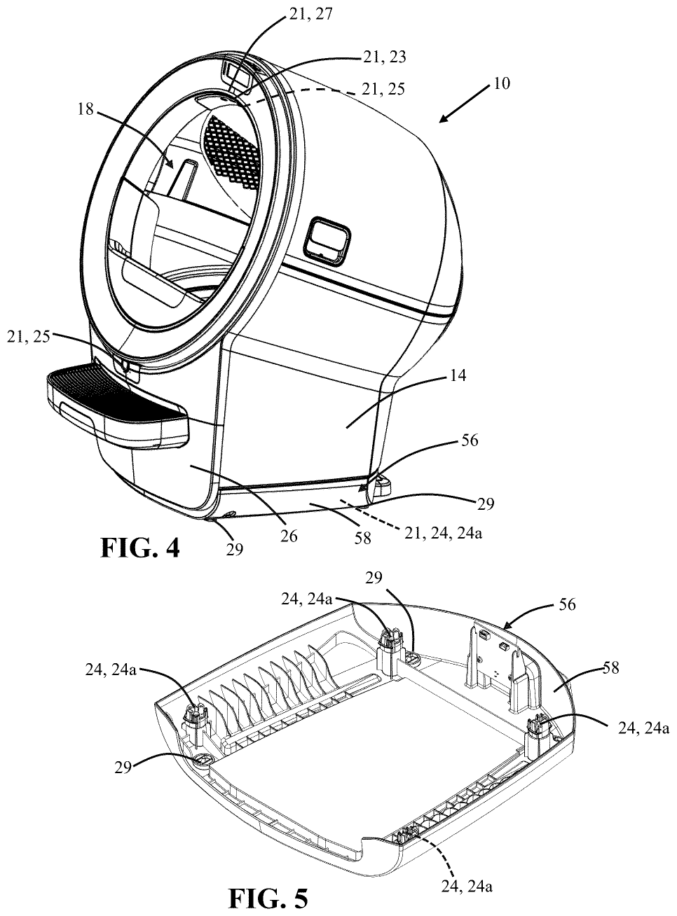

Some or all of the teachings of one illustrative example may be combined with some or all of the teachings of another illustrative example in any combination. For example, the scale plate assembly 56 of FIGS. 4 and 5 with any of the sensing devices of FIG. 2 or 3. For example, any of the mass sensors of FIG. 3 with any of the litter devices 10 of FIGS. 1, 2, 4, and 5.

FIG. 1 illustrates a litter device 10. The litter device 10 includes a chamber 12. The chamber 12 is rotatably supported by a base 14. The chamber 12 includes an entry opening 18. Located about the entry opening 18 is a bezel 16.

FIG. 2 illustrates a litter device 10. One or more sensing devices 21 may be adjacent to the entry opening 18. The litter device 10 includes a bezel 16. The bezel 16 houses a sensor mount 20. The sensor mount 20 supports one or more sensing devices 21. The one or more sensing devices 21 may include one or more emitting sensors 23, cameras 21, mass sensors 24, identification sensors 27, or a combination thereof.

FIG. 3 illustrates a litter device 10. The litter device 10 includes one or more mass sensors 24. The one or more mass sensors 24 may include one or more device mass sensors 24a, waste bin mass sensors 24b, chamber mass sensors 24c, or any combination thereof.

The litter device 10 may include further sensing devices 21. The sensing devices may include an emitting sensor 23 or other sensing devices 21 as illustrated in FIG. 2 or described within this same specification.

The one or more device mass sensors 24a may be located at a bottom of the device 10, such as at a bottom of the base 14. For example, the one or more device mass sensors 24a may be integrated into one or more feet 29 of the litter device 10. As shown in FIGS. 4 and 5, the one or more device mass sensors 24a may be part of a scale plate assembly 56 and/or offset and separate from the feet 29. The one or more device mass sensors 24 may be configured to detect a mass of the entirety of the litter device 10.

The one or more waste bin mass sensors 24b may be located adjacent to or at the bottom of a waste bin 26. The one or more waste bin sensors 24b may be configured to detect a mass of the waste bin 26. The one or more waste bin sensors 24b may be located between a base 14 and the waste bin 26. The mass of the waste bin 26 may be isolated from other components of the litter device and their respective masses.

The one or more chamber mass sensors 24c may be located adjacent to and/or toward a bottom of the chamber 12. The one or more chamber mass sensors 24c may be located on a support 28. The one or more chamber mass sensors 24c may be located near or cooperate with one or more bearings (not shown) of the support 28. The one or more mass sensors 24c may function to isolate the mass of the chamber 12 with respect to the other components of the litter device 10 (e.g., other components external of the chamber).

FIG. 3 illustrates waste 30 deposited by an animal into litter 36. The litter 36 resides in the chamber 12. Waste 30 may include urine 32 and/or feces 34. Most often, an animal only deposits a single type of waste per visit (e.g., urine or feces) and not both types of waste (e.g., both urine and feces) during a single visit. The litter device 10 is configured to remove the waste 30 from the chamber 12 and transfer the waste 30 into the waste bin 26 with a septum 38. During an automated cleaning cycle, the septum 38 sifts through the litter 36. It is possible that either the chamber 12 rotates to cause movement of the septum 38 or the septum 38 rotates within the chamber 12 to result in the sifting.

FIGS. 4 and 5 illustrate a litter device 10 and scale plate assembly 56 of the litter device 10. The litter device 10 may include one or more sensing devices 21. One or more sensing devices 21 may be located adjacent to the entry opening 18. For example, one or more sensing devices 21 may include one or more emitting sensors 23, cameras 25, identification sensors 27, the like, or a combination thereof. Although shown adjacent to the entry opening 18, one or more of these sensing devices could be located elsewhere, such as part of and/or within the base 14. For example, a camera 25 may be located between the entry opening 18 and the waste drawer 26. For example, an identifications sensor 27 may be located within the base, between the entry opening 18 and the waste drawer 26, or both. The litter device 10 includes one or more mass sensors 24. The one or more mass sensors 24 may be one or more device mass sensors 24a. The one or more device mass sensors 24a may be part of a scale plate assembly 56. The scale plate assembly 56 is below the base 14. The one or more device mass sensors 24a may be separate from one or more feet 29 (e.g., not included as part of the feet, distanced or offset from the feet). The one or more device mass sensors 24a may be located between a scale plate 58 and the base 14.

FIG. 5 illustrates a scale plate assembly 56. The scale plate assembly 56 includes a scale plate 58. The scale plate assembly 56 includes one or more device mass sensors 24a. The one or more device mass sensors 24a are biased toward the corners of the scale plate 58. The one or more device mass sensors 24a may be offset from one or more feet 29 (e.g., the feet may extend downward from a bottom of the scale plate 58). The one or more device mass sensors 24a may be located between the base 14 and the scale plate 58. The one or more device mass sensors 24a may be located on the opposite side of the scale plate 58 as the one or more feet 29.

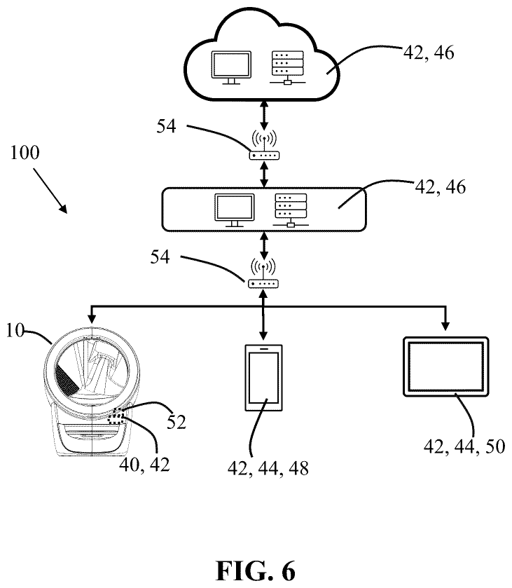

FIG. 6 illustrates a system 100. The system 100 shows a litter device 10. The litter device 10 includes one or more onboard controllers 40. The system 100 includes one or more computing devices 42. The computing devices 42 may include the controller 40, one or more personal computing devices 44, and/or remote computing devices 46. Personal computing devices 44 may include one or more mobile phones 48, tablets 50, laptops (not shown), desktop computers (not shown), and/or the like. One or more remote computing devices 46 may include one or more processors, servers, databases, and/or the like. The litter device 10 may include one or more communication modules 52. The communication module 52 may allow for the litter device 10 to communicate directly and/or indirectly to the one or more computing devices 42. The communication module 52 may be configured to communicate via one or more communication hubs 54.

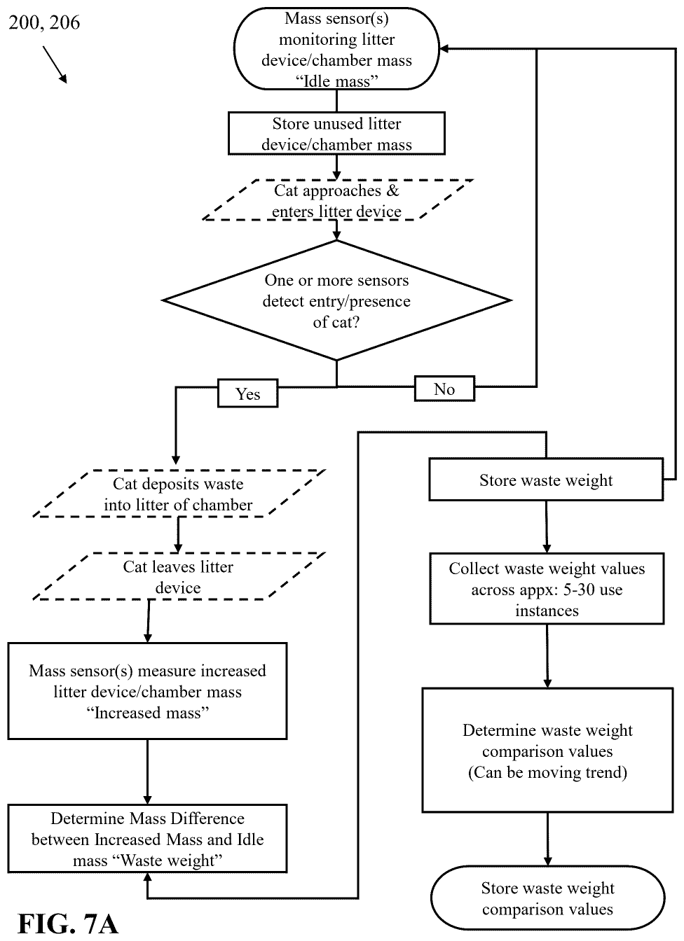

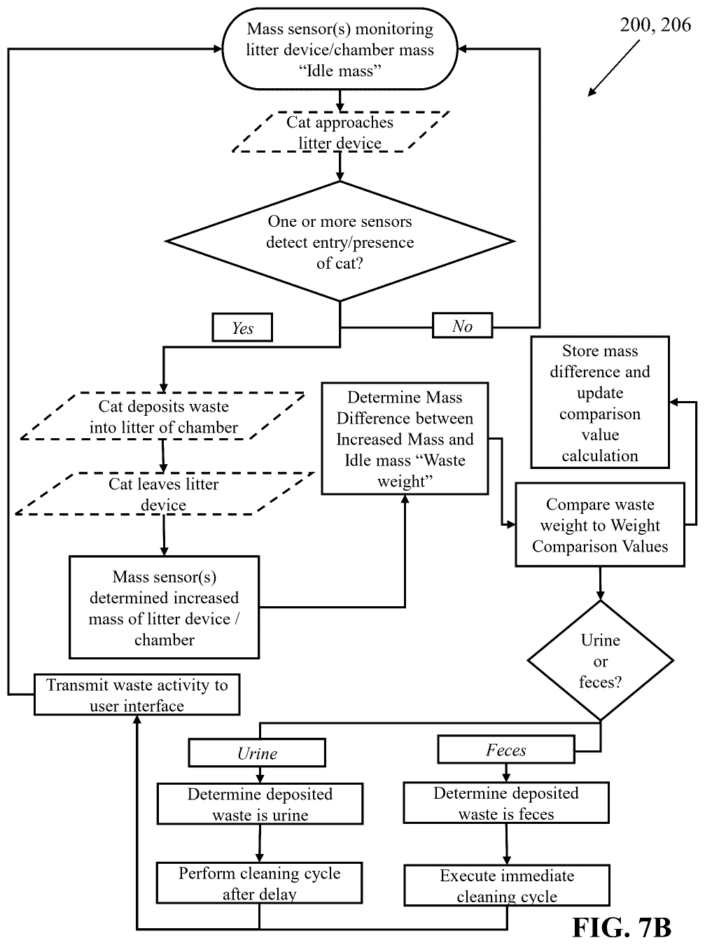

FIGS. 7A and 7B illustrate a waste identification method 200. The method may include a pre-sift chamber weight algorithm 206 (see FIG. 7B). FIG. 7A illustrates a method of initially determining the mass comparison values used by the algorithm 206. This method 200 and algorithm 206 are further described in Working Example A.

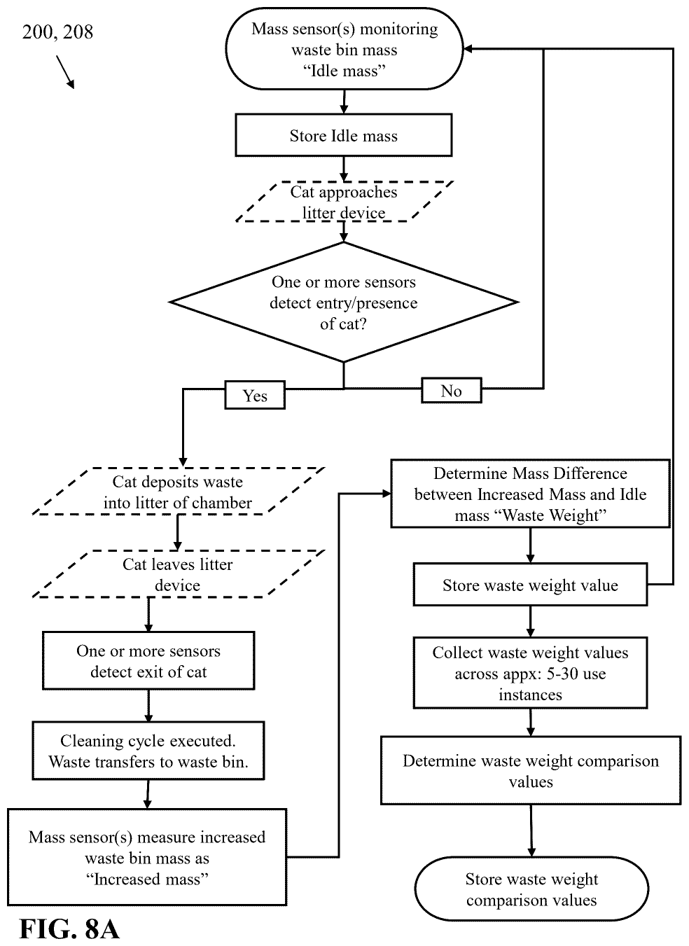

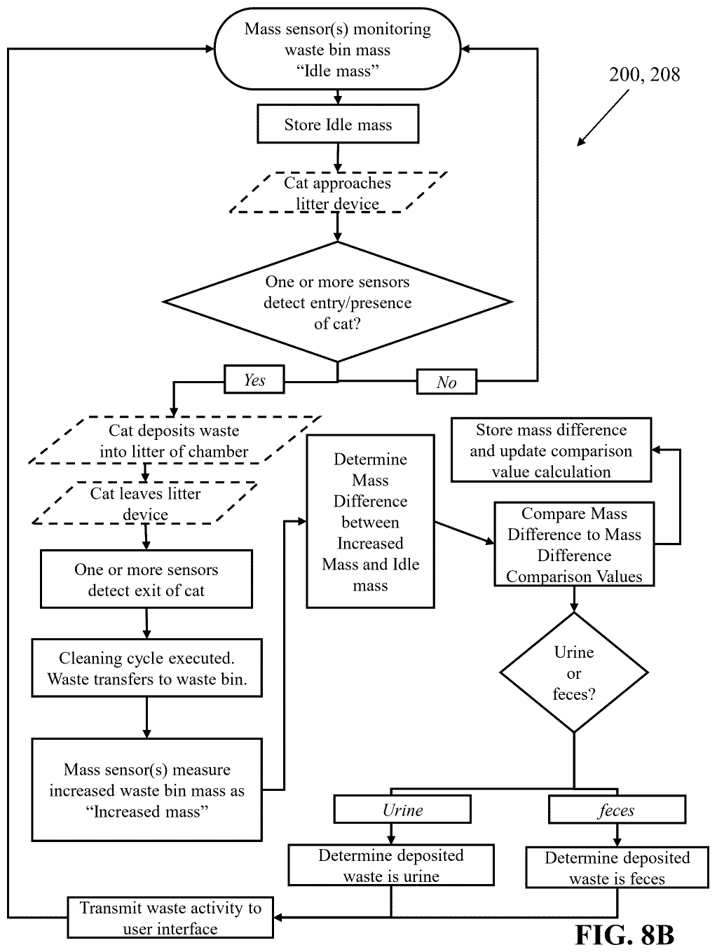

FIGS. 8A and 8B illustrate a waste identification method 200. The method may include a post-sift waste bin weight algorithm 208 (see FIG. 8B). FIG. 8A illustrates a method of initially determining the weight comparison values used by the algorithm 208. This method 200 and algorithm 208 are further described in Working Example B.

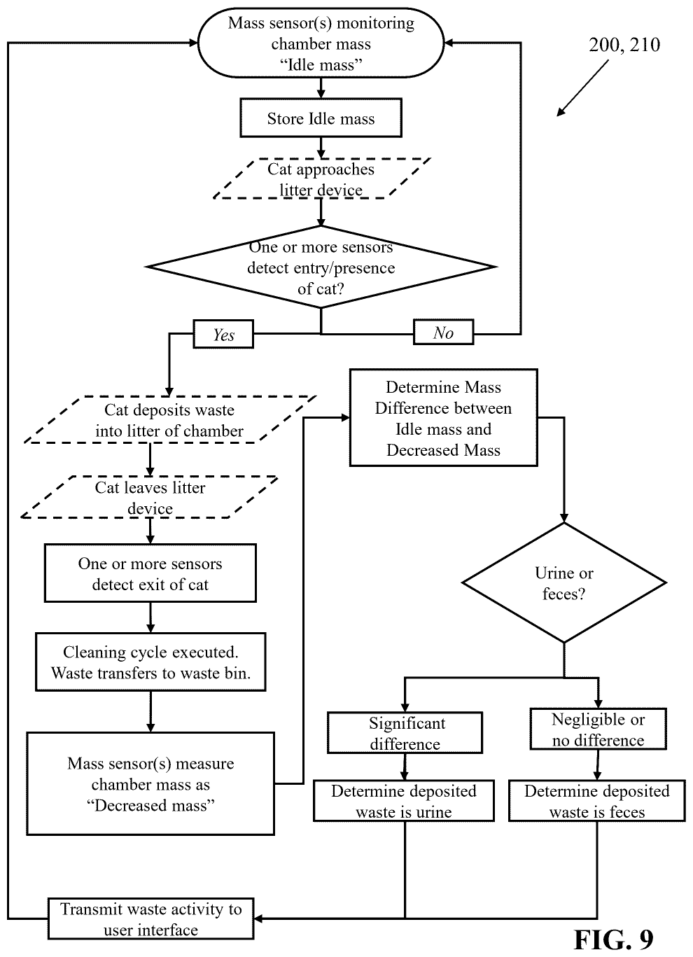

FIG. 9 illustrates a waste identification method 200. The method may include a post-sift chamber weight algorithm 210. This method 200 and algorithm 210 are further described in Working Example C.

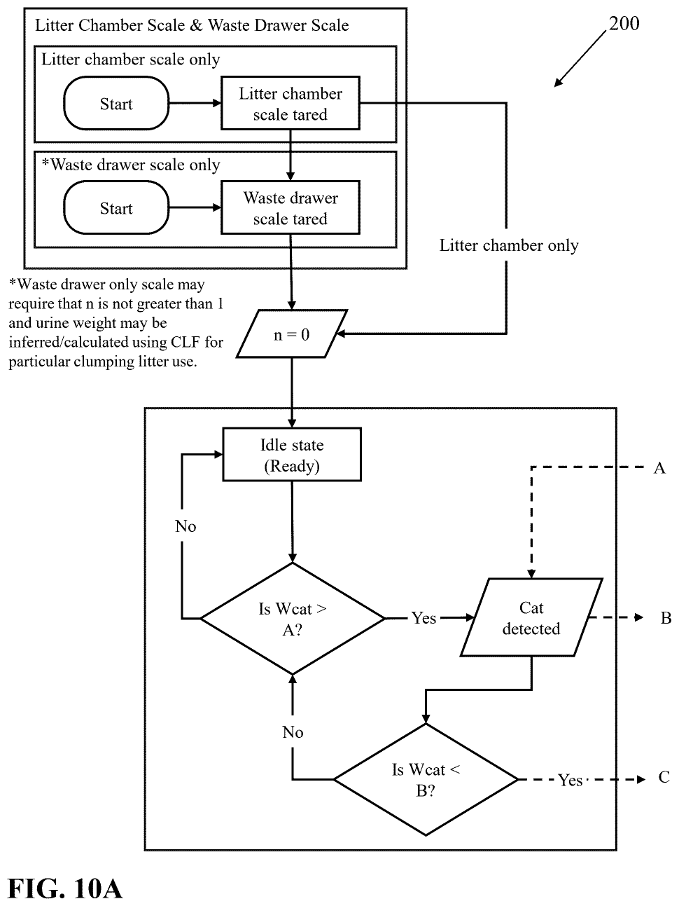

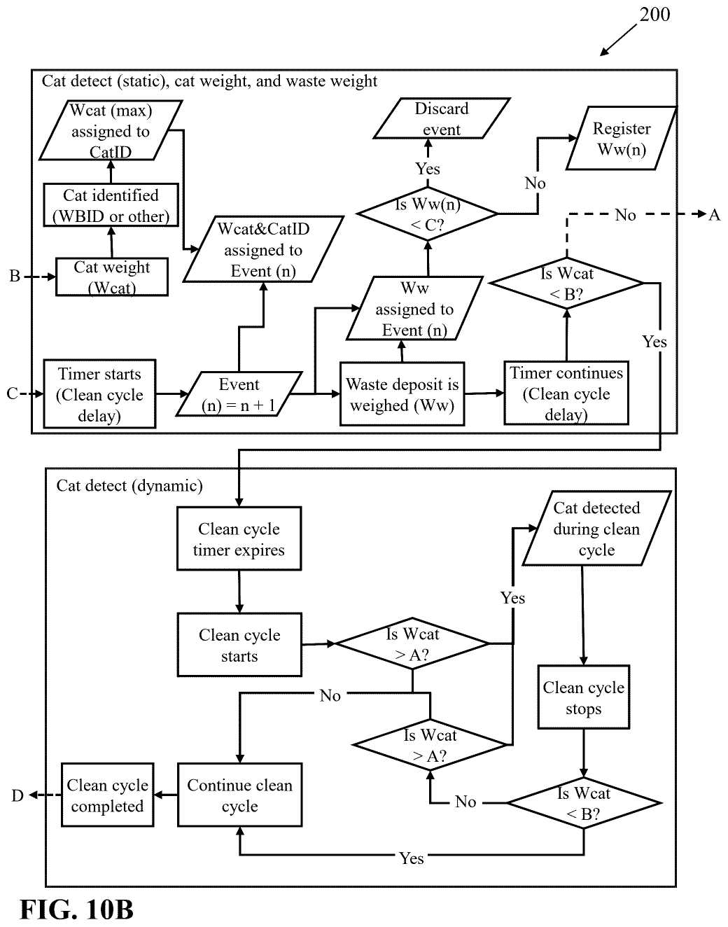

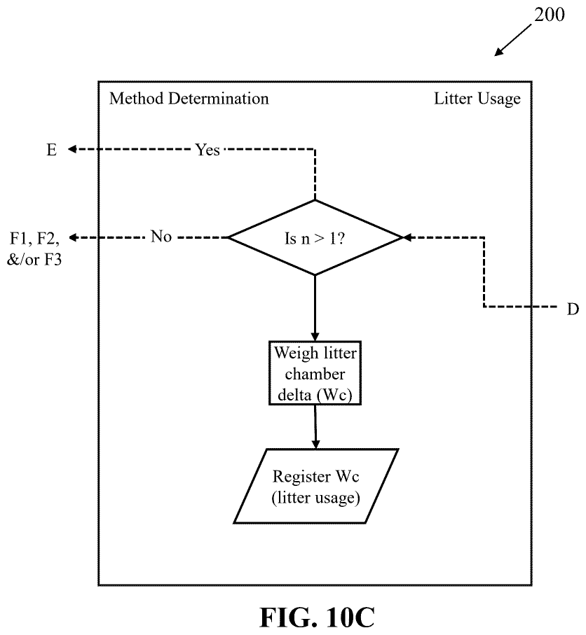

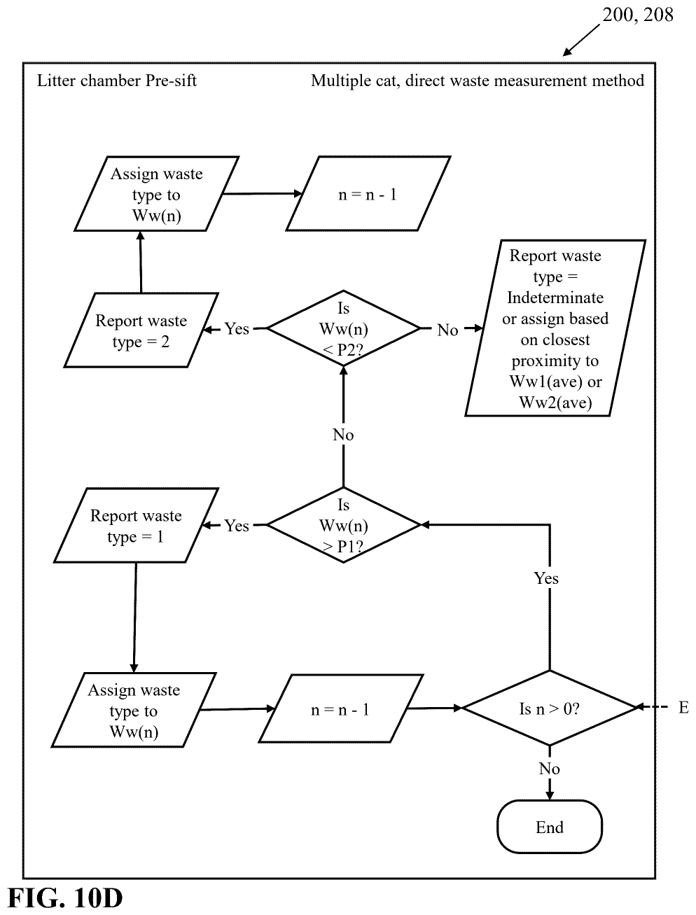

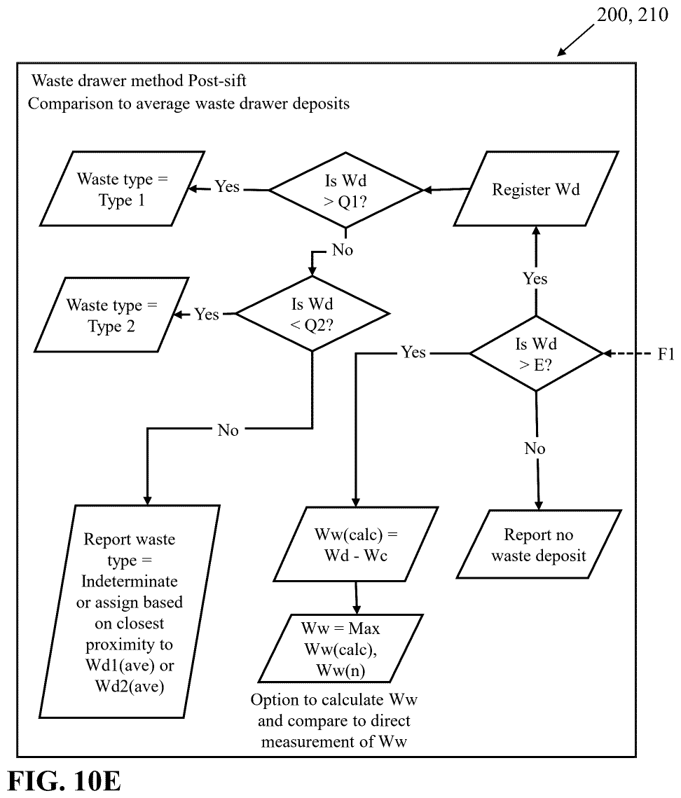

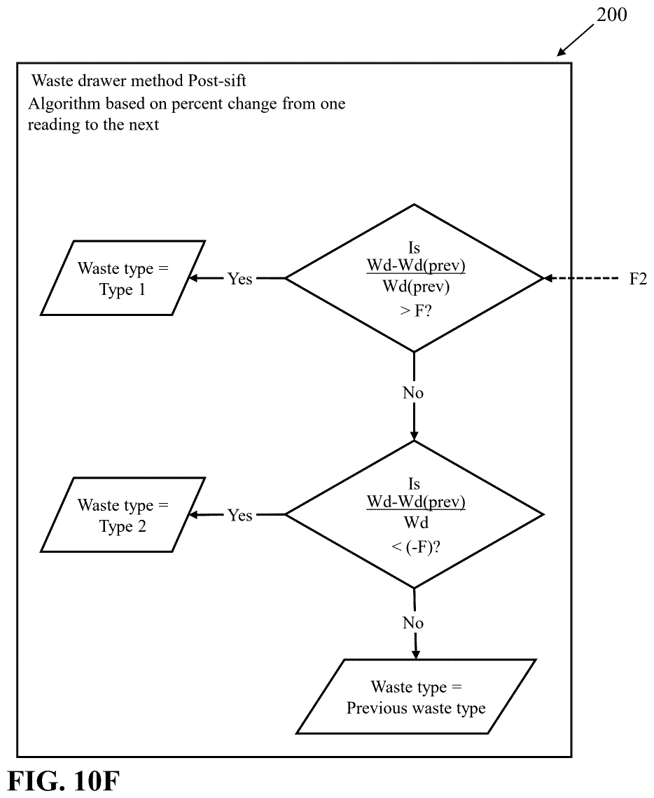

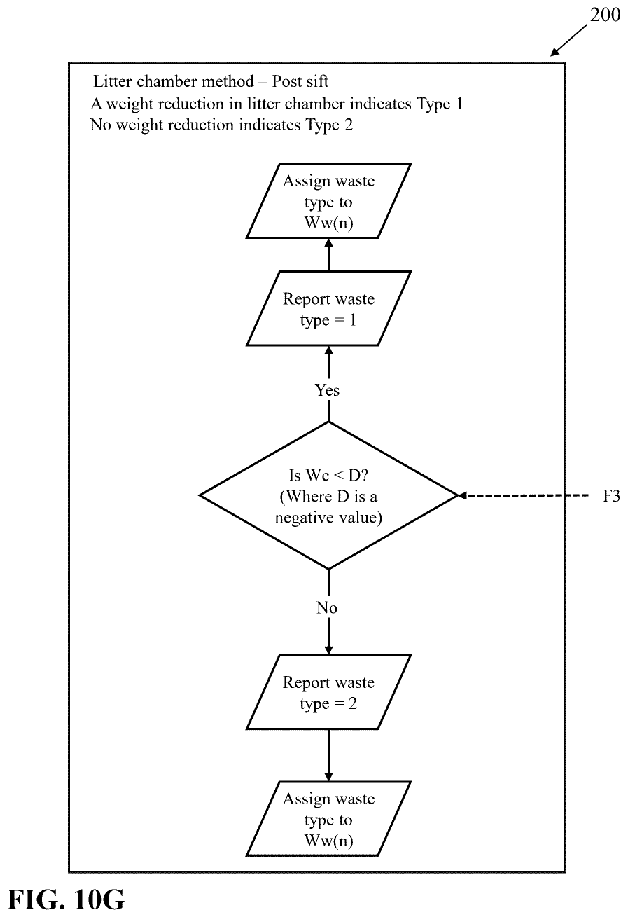

FIGS. 10A-10G illustrate a waste identification method 200. The waste identification method 200 can use one or more waste type identification algorithms, singularly or in combination with one another. This method 200 and algorithms are described in detail in Working Example D.

### Working Examples of Waste Identification Method(s) 200

### Example A: Waste Identification with Pre-Sift Chamber Weight Algorithm (See FIGS. 7A-B)

Establishing waste weight comparison values (see FIG. 7A): One or more mass sensors 24 monitor a mass of the litter device 10 or just the chamber 12 in isolation. This mass may be referred to as an idle mass. A cat enters a chamber 12 of a litter device 10. One or more sensors detect the animal's entry and/or presence into the chamber 12. The cat may move around, paw at litter, and find a comfortable position for eliminating waste. The cat eliminates waste 30, which is either urine 32 or feces 34, into the chamber 12. The cat then departs the chamber 12. Upon leaving the chamber 12, the one or more mass sensors 24 determine an increased mass of the litter device 10 or the chamber 12 in isolation. This increased mass is due to the waste 30 now residing within the chamber 12 after elimination and departure of the animal. A mass difference is automatically calculated. The mass difference may be the difference between the increased mass and the idle mass. The mass difference may be referred to as the waste weight or waste deposit weight. The mass difference is then stored. Optionally, if more than one animal uses the litter device, the stored mass difference may also be associated with an identification of the animal. After a number of instances (e.g., 5-30) or time period (e.g., 3 days to 2 weeks), the collected mass difference values are evaluated to determine one or more weight comparison values. The comparison values are then stored for use in identifying waste by weight. The comparison values may be iteratively updated over time.

Identifying waste by waste weight (see FIG. 7B): One or more mass sensors 24 monitor a mass of the litter device 10 or just the chamber 12 in isolation. This monitored mass may be the idle mass. A cat enters a chamber 12 of a litter device 10. One or more sensors detect the animal's entry and/or presence into the chamber 12. The cat eliminates waste 30, in the form of urine 32 or feces 34, into the chamber 12. The cat exits the chamber 12. One or more sensors detect the animal leaving the chamber 12. One or more mass sensors 24 determine an increased mass of the litter device 10 or the chamber 12 in isolation. The increased mass is due to the waste 30 now residing in the chamber 12. A mass difference is automatically calculated. This mass difference is referred to as the waste weight or waste deposit weight. The mass difference is compared to one or more comparison values. Based on the comparison, the method automatically determines if the waste is urine or feces. If the waste weight is indicative of feces, a cleaning cycle may be promptly initiated upon departure of the animal from the litter device and cancel the cleaning cycle timer. If the mass difference is indicative of urine, a cleaning cycle may occur after a cleaning cycle timer ends.

### Example B: Waste Identification with Post-Sift Waste Bin Weight Algorithm (See FIGS. 8A-B)

Establishing waste weight comparison values (see FIG. 8A): One or more mass sensors 24 monitor a mass of the waste bin 26 in isolation compared to the rest of the litter device 10. This mass may be referred to as an idle mass. A cat enters a chamber 12 of a litter device 10. One or more sensors detect the animal's entry and/or presence into the chamber 12. The cat eliminates waste 30, which is either urine 32 or feces 34, into the chamber 12. The cat then departs the chamber 12. One or more sensors detect departure of the cat from the litter device 10. Upon leaving, or after a delay, a cleaning cycle is initiated. During the cleaning cycle, litter 36 is sifted and waste is separated 30 therefrom. The waste 30 is then transferred from the chamber 12 to the waste bin 26. After the cleaning cycle, the one or more mass sensors 24 determine an increased mass of the waste bin 26. This increased mass is due to the waste 30 now residing within the waste bin 26 after a cleaning cycle. A mass difference is automatically calculated. This mass difference is the difference between the increased mass and the idle mass. The mass difference may be referred to as the waste weight. The waste weight is then stored. Optionally, if more than one animal uses the litter device, the stored mass difference may also be associated with an identification of the animal. After a number of instances (e.g., 5-30) or time period (e.g., 3 days to 2 weeks), the collected waste weight values are evaluated to determine one or more comparison values. The comparison values may be specific to an animal or to a device. The comparison values are then stored for use in identifying waste. The comparison values may be iteratively updated over time.

Identifying waste by waste bin mass (see FIG. 8B): One or more mass sensors 24 monitor a mass of the waste bin 26 in isolation compared to the rest of the litter device 10. This mass may be referred to as an idle mass. A cat enters a chamber 12 of a litter device 10. One or more sensors detect the animal's entry and/or presence into the chamber 12. The cat eliminates waste 30, which is either urine 32 or feces 34, into the chamber 12. The cat then departs the chamber 12. One or more sensors detect departure of the cat from the litter device 10. Upon leaving, or after a delay, a cleaning cycle is initiated. During the cleaning cycle, litter 36 is sifted and waste is separated 30 therefrom. The waste 30 is then transferred from the chamber 12 to the waste bin 26. After the cleaning cycle, the one or more mass sensors 24 determine an increased mass of the waste bin 26. This increased mass is due to the waste 30 now residing within the waste bin 26 after a cleaning cycle. A mass difference is automatically calculated. The mass difference is referred to as a waste weight. The waste weight is compared to one or more waste weight comparison values. Based on the comparison, the method automatically determines if the waste is urine or feces.

Exemplary input and output values from testing of a post-sift waste bin weight change algorithm are provided below. In this example, the threshold value is set at 50%. The change in the weight of the waste bin from before to after a cleaning cycle is executed is referred to as the delta weight of the waste drawer. The difference between the delta in weight of the waste drawer after sifting and from one cycle to a next is referred to as delta previous weight. It can be seen how when the rate of change between one weight reading and a preceding reading is below-50%, then a waste type of 2 (feces) is assigned. When the rate of change is greater than 50%, a waste type of 1 (urine) is assigned. And if the rate of change is not less than-50% or greater than 50%, then the same waste type as the previous waste type is assigned.

TABLE 1
Test data of post-sift waste bin weight change algorithm

| | | | Delta Percentage | | |
|---|---|---|---|---|---|
| | | | (increasing divide | | |
| | Delta Weight | Delta | by previous, | | |
| Visit | of Waste | Previous | decreasing device | Waste | Waste |
| Sequence | Drawer (oz) | Weight | by current) | Type Code | Type |
| 1 | 1.95 | 0.00 | 0% | Initial | Initial |
| 2 | 2.20 | 0.25 | 12.82% | Initial | Initial |
| 3 | 2.40 | 0.20 | 9.09% | Initial | Initial |
| 4 | 1.90 | −0.5 | −26.32% | Initial | Initial |
| 5 | 0.95 | −0.95 | −100.00% | 2 | Fecal |
| 6 | 2.00 | 1.05 | 110.53% | 1 | Urine |
| 7 | 1.75 | −0.25 | −14.29% | 1 | Urine |
| 8 | 1.89 | 0.14 | 8.00% | 1 | Urine |
| 9 | 2.00 | 0.11 | 5.82% | 1 | Urine |
| 10 | 1.02 | −0.98 | −96.08% | 2 | Fecal |
| 11 | 1.70 | 0.68 | 66.67% | 1 | Urine |
| 12 | 1.80 | 0.10 | 5.88% | 1 | Urine |
| 13 | 1.90 | 0.10 | 5.56% | 1 | Urine |
| 14 | 1.95 | 0.05 | 2.63% | 1 | Urine |
| 15 | 0.87 | −1.08 | −124.14% | 2 | Fecal |
| 16 | 2.20 | 1.33 | 152.87% | 1 | Urine |
| 17 | 2.40 | 0.20 | 9.09% | 1 | Urine |
| 18 | 1.65 | −0.75 | −45.45% | 1 | Urine |
| 19 | 1.93 | 0.28 | 16.97% | 1 | Urine |
| 20 | 1.02 | −0.91 | −89.22% | 2 | Fecal |
| 21 | 1.95 | 0.93 | 91.18% | 1 | Urine |
| 22 | 2.00 | 0.05 | 2.56% | 1 | Urine |
| 23 | 2.01 | 0.01 | 0.50% | 1 | Urine |
| 24 | 2.10 | 0.09 | 4.48% | 1 | Urine |
| 25 | 0.75 | −1.35 | −180.00% | 1 | Fecal |
| 26 | 1.90 | 1.15 | 153.33% | 1 | Urine |
| 27 | 1.85 | −0.05 | −2.70% | 1 | Urine |

### Example C: Waste Identification by Post-Sift Chamber Weight Algorithm (FIG. 9)

One or more mass sensors 24 monitor a mass of the chamber 12 in isolation compared to the rest of the litter device 10. This mass may be referred to as an idle mass. A cat enters a chamber 12 of a litter device 10. One or more sensors detect the animal's entry and/or presence into the chamber 12. The cat eliminates waste 30, which is either urine 32 or feces 34, into the chamber 12. The cat then departs the chamber 12. One or more sensors detect departure of the cat from the litter device 10. Upon leaving, or after a delay, a cleaning cycle is initiated. During the cleaning cycle, litter 36 is sifted and waste is separated 30 therefrom. The waste 30 is then transferred from the chamber 12 to the waste bin 26. After the cleaning cycle, the one or more mass sensors 24 determine a decreased mass of the chamber 12. This decreased mass of the chamber 12 takes into account litter which has been removed from the chamber 12 during a cleaning cycle. As significantly more litter sticks and clumps with urine as compared to coating feces, more litter is removed from the chamber with waste in the form of urine as compared to waste in the form of feces. A mass difference (delta value) is automatically calculated. The mass difference is the difference between the decreased weight and the idle weight of the chamber. This may be referred to as a chamber weight. If there is a noticeable mass difference, it may be determined that the waste was urine. If there is not a noticeable mass difference, it may be determined that the waste was feces. A threshold value may be used to determine if there is or is not a noticeable mass difference.

### Example D: Waste Identification Method by Various Means (FIGS. 10A-10G)

As illustrated in FIG. 10A, the method 200 starts with the one or more mass sensors 24 being tared such that the value of the chamber 12 and litter 36, the waste bin 26 and litter 36, or both register at a value of 0.0 lbs. (n=0). The mass sensors 24 may be the chamber mass sensors 24c or waste bin sensors 24b.

When tared, the litter device 10 is in an idle state (also a ready state). The chamber 12 is monitored for a cat weight (Wcat) that exceeds a cat detection threshold (A). If the cat detection threshold (A) is not met or exceeded (Wcat≤A), the litter device 10 remains in an idle state. If the cat detection threshold (A) is exceeded (Wcat>A), then it is determined that a cat has entered the chamber 12. Upon determining a cat has entered the chamber 12, a cat detection signal is transmitted to a controller 40. As long as the cat weight (Wcat) remains above the cat detection threshold (A) (Wcat>A) and above or equal to the cat detection hysteresis threshold (B) (Wcat≥B), it assumed the cat is still within the chamber 12.

As illustrated in FIG. 10B, via flow arrow B, during the period of time when the cat is in the chamber and the cat weight (Wcat) is greater than the cat detection threshold (A) (Wcat>A), the peak weight recorded (max) is registered as the weight of the cat (Wcat). This allows for the cat to be identified (CatID) by a weight which may be referred to as weight-based identification (WBID). In addition to, or in lieu of, weight-based identification, a cat may be identified by camera, and/or by any other means, such as a collar with a wireless tag. Once the identification of the cat is determined, the cat weight (Wcat) may be associated with an identified cat (CatID).

As illustrated in FIG. 10B, via flow arrow C, when the cat weight (Wcat) is less than the cat detection hysteresis threshold (B) (Wcat<B), it is assumed that the cat has left the chamber 12. This triggers a cleaning cycle timer to start. Once the cleaning cycle timer starts or at the same time, a recording of an event (n) occurring (n+1) is triggered. An event may be defined as usage of the litter device by a cat. The event (n) is paired with both the cat weight (Wcat) and the identity of the cat (CatID). When the cleaning cycle timer starts, the weight of the waste (Ww) is recorded. The weight of the waste (Ww) is also paired with the event (n) making it an event specific weight of waste (Ww(n)). The weight of the waste (Ww(n)) may be the weight the mass sensor(s) 24 are registering after departure of the cat from the chamber 12. This is possible as the mass sensor(s) 24 were originally tared at 0.0 lbs.

If the waste deposit weight (Ww(n)) is less than a minimum detection threshold (C) (Ww(n)<C), it is determined that no waste was deposited. The cleaning cycle timer is cancelled. No event (n) is recorded, or if temporarily store, it is discarded.

If the waste deposit weight (Ww(n)) is not less than the minimum detection threshold (C), in other words greater than or equal to (Ww(n)≥C), and the number of events (n) is equal to 1 (n=1), it is determined that a single waste deposit by a single cat has occurred and this weight (Ww(n)) is registered. The cleaning cycle timer continues.

As illustrated in FIGS. 10B and 10A, via flow arrow A, if a cat reenters or a different cat enters the chamber 12 after the weight of the weight deposit (Ww(n)) is recorded, the process is started over at “Cat Detected” (such as shown in FIG. 10A). Due to the possibility of multiple cats making waste deposits before a cleaning cycle, it may be advantageous to record and assign waste deposit weights to each cat identified. In the case of multiple deposits (events (n)) and the possibility that the type of deposits are mixed (e.g., urine and feces), it may be possible to determine feces versus urine based on historical average deposit weights of urine and feces or other comparison values. If a waste deposit weight (Ww(n)) is registered more than once prior to the cleaning cycle timer expiring, subsequent readings will subtract the prior gross reading to determine the weight of waste deposited for each deposit (event (n)) and cat identified (CatID). Those individual waste weights will then be compared to historical typical deposit weights for urine and fecal to determine type of waste for each cat identified. In this case, a pre-sift waste weight algorithm may be beneficial.

As further shown in FIG. 10B, once the cleaning cycle timer has expired, a cleaning cycle is initiated. During the cleaning cycle, the litter is sifted through, separating the waste from the litter. The waste is then transferred to the waste bin. During the cleaning cycle, the weight is continuously monitored to ensure a cat is not detected in the chamber 12. If at any point the monitored cat weight (Wcat) exceeds the cat detection threshold (A) (Wcat>A), the cleaning cycle is immediately stopped.

As shown in FIG. 10C, a waste type identification algorithm may be selected based on how many waste events occurred before a cleaning cycle was executed. In other words, determining if there were multiple uses of a litter device by one or more cats. If the number of events (n) is greater than 1 (n>1), then it is determined that there have multiple instances. If the number of events (n) is not greater than one, then it is determined that there has been a single use of the litter device. If the number of events (n) is not greater than 1, a weight change value (Wc) of the chamber 12 is recorded. If the number of events (n) is not greater than one, the method may process to one or more of the algorithms as shown in FIGS. 10E-10G (shown via flow arrow F1, F2, and F3). If the number of events (n) is greater than 1 (n>1), then the method may proceed to an algorithm illustrated in FIG. 10D (shown via flow arrow E).

FIG. 10D, via flow arrow E from FIG. 10C, illustrates application of a pre-sift waste chamber weight algorithm. After the cat exists the chamber 12 and prior to the cleaning cycle being initiated, the weight of the waste deposited (Ww(n)) is compared a lower limit (P1). Specifically, if the weight of the waste deposited (Ww(n)) is greater than the lower limit (P1) (Ww(n)>P1), then a waste type is assigned to the waste. For example, a waste type of urine may be assigned. If the weight of the waste deposited (Ww(n)) is not greater than the lower limit (P1) it is then compared to an upper limit (P2). If the weight of the waste deposited (Ww(n)) is less than the upper limit (P2) (Ww(n)<P2), then a waste type is assigned to the waste. For example, a waste type of feces may be assigned. In other words, if the weight of the waste deposited (Ww(n)) falls between the lower and upper limit, it is assigned a waste type of urine and if the weight of the waste deposited (Ww(n)) falls below the lower limit, it is assigned a waste type of feces. This is due to feces usually weighing less than urine. If the weight of the waste deposited (Ww(n)) outside the lower and upper limits (P1, P2), then it is possible that the type of waste is not assigned (e.g., indeterminate) or assigned based on proximity to closest comparison value (e.g., average urine weight, average feces weight). After the type of waste is determined, then the event count (n) is reduced by a value of 1 (n=n−1). The pre-sift chamber weight algorithm may be applied to each waste event until the event count (n) is brought back to a value of zero.

FIG. 10E, via flow arrow F1 from FIG. 10C, illustrates application of a post-sift waste bin weight algorithm. In this case, after a cleaning cycle occurs, the weight change of the waste drawer (Wd) is compared to a waste drawer minimum detection threshold (E). If the weight change of the waste drawer (Wd) is not greater than the minimum detection threshold (E), then it is determined that no waste was deposited. If the weight change of the waste drawer (Wd) is greater than the threshold (E) (Wd>E), then the weight change (Wd) is recorded. The recorded weight change (Wd) is then compared to a lower limit (Q1). If the weight change (Wd) is greater than the lower limit (Q1) then the waste is identified as urine (Type 1). If the weight change (Wd) is not greater than the lower limit (Q1), the weight change (Wd) is compared to the upper limit (Q2). If the weight change (Wd) is found to be less than the upper limit (Q2) (Wd<Q2), then the waste is identified as feces (Type 2). In other words, if the weight change (Wd) falls between the lower and upper limit, it is assigned a waste type of urine and if the weight change (Wd) falls below the lower limit, it is assigned a waste type of feces. If the weight change (Wd) is found to not be below the upper limit (Q2), in other words above the upper limit (Q2), then it is possible that the type of waste is not assigned (e.g., indeterminate) or assigned based on proximity to closest comparison value. It is also possible to compare the weight change of the waste bin (Wd) with the weight of the waste deposit (Ww) as recorded earlier in the method.

FIG. 10F, via flow arrow F2 from FIG. 10C, illustrates application of a post-sift waste bin change algorithm. In this case, a rate of change from an immediately previous weight change of a waste drawer and the present weight change of the waste drawer (Wd) after a cleaning cycle is compared to a rate of change algorithm threshold (F) which is provided as a percent change. The waste is identified as urine (Type 1) if:

$$\frac{\begin{matrix}Weight change of waste drawer ( Wd ) - \\ Previous cycle weight change of waste drawer ( Wd )\end{matrix}}{Previous cycle weight change of waste drawer ( Wd )} > F$$

If the rate is not above the rate of change threshold (F), then the a second calculation is completed. The waste is identified as feces (Type 2) if:

$$\frac{\begin{matrix}Weight change of waste drawer ( Wd ) - \\ Previous cycle weight change of waste drawer ( Wd )\end{matrix}}{Weight change of waste drawer ( Wd )} < - F$$

If the waste is not identified as feces via the second algorithm, then the waste type is identified as being the same as the previous waste type. In other words, if there is a minimal rate of change, the waste type is very likely the same waste type as the previous waste event.

FIG. 10G, via flow arrow F3 from FIG. 10C, illustrates the method implementing the post-sift chamber weight algorithm. In this case, the weight change of the chamber (Wc) is monitored. The weight change (Wc) compares the weight of chamber before usage by the cat and then after a cleaning cycle is executed. The waste is identified as urine (Type 1) if the weight change (Wc) is less than the minimum detection threshold (D). The waste is identified as feces (Type 2) if the weight change (Wc) is greater than or equal to the minimum detection threshold (D). The minimum detection threshold (D) is provided as a negative value, as there is always expected to be a minimal loss in chamber weight after a cleaning cycle. This is due to litter sticking to both urine and feces and then transferring from the chamber to the waste bin. So even though a significantly less amount of litter sticks feces, there is still some amount of litter which sticks to the feces and leaves the chamber.

### Flow Chart Abbreviations in Working Example D and FIGS. 10A-10G.

Wcat: Weight of cat
WBID: Weight-based identification of cat
CatID: Cat identification
CLF: Clumping material factor
n: Events (e.g., an event may be the time period and/or occurrence defined by cat detected to not detected, the period while cat is in the chamber)
Ww(n): Weight of waste by event (e.g., weight of waste material only, direct measurement of waste deposit(s) prior to a cleaning cycle initiating)
Ww(calc): Weight of waste calculated (e.g., weight of waste material only, calculated value)
Wc: Delta or difference in weight of litter chamber (e.g., weight of only litter material in chamber)
Wd: Delta or difference in weight of waste drawer (e.g., weight of both waste and litter material in waste drawer)
A: Cat detection threshold
B: Cat detection hysteresis threshold
C: Ww(n) minimum detection threshold (positive value)
D: Wc minimum detection threshold (negative value)
E: Wd minimum detection threshold factor (positive value)
F: Rate of change algorithm threshold (value may be a percentage)
Waste Type 1: Urine (may also be indicated as Type 1) Waste Type 2: Feces (may also be indicated as Type 2)
Ww1(ave): Average waste weight (Ww) of Waste Type 1 (average may be for specific CatID)
Ww2(ave): Average waste weight (Ww) of Waste Type 2 (average may be for specific CatID)
P: Waste weight data range (may be a percentage value)
Q: Waste drawer deposit weight data range (may be a percentage value)
P1: Lower limit of Ww1 (e.g., lower limit of waste weight relative to Waste Type 1, may be calculated as Ww1(ave)×(1−P))
P2: Upper limit of Ww2 (e.g., upper limit of waste weight relative to Waste Type 2, may be calculated as Ww2(ave)×(1+P))
Wd1(ave): Average waste drawer deposit weight (Wd) of Waste Type 1 (average may be for specific CatID)
Wd2(ave): Average waste drawer deposit weight (Wd) of Waste Type 2 (average may be for specific CatID)
Q1: Lower limit Wd1 (e.g., lower limit of waste weight relative to Waste Type 1, may be calculated as Wd1(ave)×(1−Q))
Q2: Upper limit of Wd2 (e.g., upper limit of waste relative to Waste Type 2, may be calculated as Wd2(ave)×(1+Q))

### Exemplary Parameters for Working Example D and FIGS. 10A-10G

$$A = 2 lbs$$

$$B = 1 lb$$

$$C = + 0.02 lbs$$

$$D = - \text{.10} lbs$$

$$E = + 0.02 lbs$$

$$F = 50 \%$$

$$P = 30 \%$$

$$Q = 40 \%$$

$$CLF = 1.5$$

### Reference Number List

10—Litter device
12—Chamber
14—Base
16—Bezel
18—Entry opening
20—Sensor mount
21—Sensing device(s)
23—Emitting sensor
24—Mass Sensor
24a—Device mass sensor
24b—Waste bin mass sensor
24c—Chamber mass sensor
25—Camera
26—Waste bin
27—Identifications sensor
28—Support
29—Feet
30—Waste
32—Urine
34—Feces
36—Litter
38—Septum
40—Controller
42—Computing device
44—Personal computing device
46—Remote computing device
48—Mobile phone
50—Tablet
52—Communication module
54—Communication hub
56—Scale plate assembly
58—Scale plate
100—System
200—Waste identification method
206—Pre-sift chamber weight algorithm
208—Post-sift waste bin weight algorithm
210—Post-sift chamber weight algorithm

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components or steps. Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for identifying a type of waste eliminated by an animal in a litter device, the method comprising:
a) automatically detecting entry of the animal into the litter device by one or more sensing devices,
wherein the litter device includes a chamber configured to retain litter and for entry and exit of an animal to eliminate waste therein, and the litter device includes a waste receptacle configured to receive the waste from the chamber,
wherein the litter device is configured to automatically execute a cleaning cycle to separate the waste from unused litter and transfer the waste to the waste receptacle, and
wherein the one or more sensing devices include one or more mass sensors, one or more emitting sensors, one or more cameras, one or more identification sensors, or a combination thereof;
b) automatically detecting departure of the animal from the litter device by the one or more sensing devices;
c) automatically accessing and executing one or more waste type identification algorithms by one or more processors to determine the type of waste eliminated by the animal;
wherein the type of waste is identified based on one or more measured weight characteristics from the one or more mass sensors; and
wherein the waste is identified either while the cleaning cycle is executed, after the cleaning cycle is executed, or both.

2. The method of claim 1, wherein the one or more mass sensors include one or more device mass sensors, chamber mass sensors, waste bin mass sensors, or a combination thereof;
wherein the one or more device mass sensors detect a weight of all or a majority of the litter device;
wherein the one or more chamber mass sensors detect a weight of the chamber of the litter device in isolation from any components outside of the chamber; and
wherein the one or more waste bin mass sensors detect a weight of a waste bin of the litter device in isolation from any components outside of the waste bin.

3. The method of claim 2, wherein upon the one or more sensing devices detecting the entry of the animal into the litter device, the one or more device mass sensors, the one or more chamber mass sensors, or both detect a weight of the animal and wherein one or more processors store the weight of the animal in one or more storage mediums.

4. The method of claim 3, wherein the weight of the animal which is stored is a peak weight, an average weight, another detected or calculated weight value, or a combination thereof.

5. The method of claim 3, wherein the method includes identifying the animal by the weight of the animal via the one or more mass sensors, by visual recognition of the animal via the one or more cameras, by an identifier of the animal via the one or more identification sensors, or a combination thereof; and
wherein the method includes associating the weight of the animal with an identity of the animal.

6. The method of claim 1, wherein the method includes initiating a cleaning cycle timer upon the one or more sensing devices detecting the departure of the animal;
wherein the cleaning cycle timer uses a default time period; and
wherein upon completion of the cleaning cycle timer, the cleaning cycle of the litter device is automatically executed.

7. The method of claim 6, wherein the method includes automatically generating a waste event record by the one or more processors upon detecting departure of the animal, which is stored in a storage medium, and the waste event record is associated with a use instance of the litter device by the animal.

8. The method of claim 7, wherein the one or more waste type identification algorithms include one or more of a pre-sift chamber weight algorithm, a post-sift waste bin weight algorithm, a post-sift waste bin weight change algorithm, a post-sift chamber weight algorithm, or any combination thereof.

9. The method of claim 8, wherein the pre-sift chamber weight algorithm automatically determines the waste type based on a weight change in the litter device from prior to the entry of the animal to before a cleaning cycle is executed.

10. The method of claim 9, wherein the pre-sift chamber weight algorithm commences with determining a waste weight;
wherein the waste weight may be the weight change relative to the weight during an idle state, prior to the entry of the animal, or both as compared to after the animal exiting the litter device, prior to execution of the cleaning cycle, while a cleaning cycle timer is running, or a combination thereof; and
wherein the weight is detected by the one or more mass sensors, and wherein the one or more mass sensors are one or more device mass sensors, one or more chamber mass sensors, or a combination thereof.

11. The method of claim 10, wherein the waste weight is compared to one or more comparison values to determine the waste type and wherein the one or more comparison values include a lower limit, an upper limit, or both;
wherein the waste weight is compared to the lower limit and if the waste weight is greater than the lower limit, the waste type is identified as urine and/or wherein the waste weight is compared to the upper limit and if the waste weight is less than the upper limit and the lower limit, the waste type is identified as feces; and
wherein the pre-sift chamber weight algorithm includes updating the waste event record with the waste type once determined.

12. The method of claim 11, wherein if the waste type is determined as feces, the cleaning cycle timer is automatically ended and the cleaning cycle is automatically initiated, or the default time period of the cleaning cycle timer is automatically reduced to a shorter period; and
wherein if the waste type is determined as urine, the cleaning cycle timer continues to run through the default time period.

13. The method of claim 8, wherein the post-sift waste bin weight algorithm determines the waste type based on a weight change in the waste bin from prior to the waste being transferred into the waste bin during a cleaning cycle.

14. The method of claim 13, wherein the post-sift waste bin weight algorithm commences with determining a waste weight;
wherein the waste weight is the weight change of the waste bin relative to the weight during an idle state, prior to animal entry, prior to the cleaning cycle, or a combination thereof as compared to after the cleaning cycle being executed; and
wherein the weight is detected by the one or more mass sensors, and wherein the one or more mass sensors are one or more waste bin mass sensors.

15. The method of claim 14, wherein the waste weight is compared to a minimum detection threshold to determine if the animal deposited a waste while in the litter device or if no waste was deposited;
if wherein if it is determined the animal deposited the waste, the waste weight is compared to one or more comparison values to determine the waste type;
wherein the waste weight is compared to a lower limit and if the waste weight is greater than the lower limit, the waste type is identified as urine and/or wherein the waste weight is compared to an upper limit and if the waste weight is less than the upper limit and the lower limit, the waste type is identified as feces; and
wherein the post-sift waste bin algorithm includes updating the waste event record with the type of waste once determined.

16. The method of claim 8, wherein the post-sift waste bin weight change algorithm correlates a percent change in weight of the waste bin as compared to a previous waste deposit weight change to the waste type.

17. The method of claim 16, wherein the post-sift waste bin weight change algorithm commences with determining a waste weight;
wherein the waste weight is the weight change of the waste bin relative to the weight during an idle state, prior to animal entry, prior to the cleaning cycle, or a combination thereof as compared to after the cleaning cycle being executed; and
wherein the weight is detected by the one or more mass sensors, and wherein the one or more mass sensors are one or more waste bin mass sensors.

18. The method of claim 17, wherein the post-sift waste bin weight change algorithm includes retrieving a previous waste weight; and
wherein a rate of change is determined from the previous waste weight to the waste weight;
wherein the rate of change is compared to one or more rate of change threshold values to determine the waste type;
wherein if the rate of change is greater than a positive rate of change threshold value, then the waste type is determined as urine, wherein if the rate of change is less than a negative rate of change threshold value, then the waste type is determined as feces, and/or wherein if the rate of change falls between the negative rate of change threshold value and the positive rate of change threshold value, the waste type is identified as a same waste type associated with the previous waste weight; and
wherein the post-sift waste bin weight change algorithm includes updating a waste event record with the waste type once determined.

19. The method of claim 8, wherein the post-sift chamber weight algorithm determines the waste type based on the quantity of litter transferred from the chamber to the waste receptacle during a cleaning cycle.

20. The method of claim 19, wherein the post-sift chamber weight algorithm commences with determining a chamber weight;
wherein the chamber weight is the weight change of the chamber relative to during an idle state as compared to after a cleaning cycle is executed;
wherein the chamber weight is detected by the one or more mass sensors, and wherein the one or more mass sensors are one or more chamber mass sensors.

21. The method of claim 20, wherein the chamber weight is compared to a minimum detection threshold;
wherein if the chamber weight is less than the minimum detection threshold, the waste type is determined as urine and/or wherein if the chamber weight is not less than the minimum detection threshold, the waste type is determined as feces; and
wherein the post-sift chamber weight algorithm includes updating a waste event record with the waste type once determined.
